(19) United States
(12) Patent Application Publication
(10) Pub. No.: US 2020/0320206 A1
(43) Pub. Date: Oct. 8, 2020

(54) SYSTEMS, METHODS, APPARATUS AND ARTICLES OF MANUFACTURE TO PREVENT UNAUTHORIZED RELEASE OF INFORMATION ASSOCIATED WITH A FUNCTION AS A SERVICE

(71) Applicant: Intel Corporation, Santa Clara, CA (US)

(72) Inventors: Rosario Cammarota, San Diego, CA (US); Fabian Boemer, San Diego, CA (US); Casimir M. Wierzynski, La Jolla, CA (US); Anand Rajan, Beaverton, OR (US); Rafael Misoczki, Hillsboro, OR (US)

(21) Appl. No.: 16/910,958

(22) Filed: Jun. 24, 2020

(51) Int. Cl. G06F 21/60; G06N 20/00; H04L 9/00; G06F 21/53; G06F 21/57; H04L 29/06

(52) U.S. Cl. CPC G06F 21/602; G06N 20/00; H04L 9/008; G06F 2221/2149; G06F 21/57; H04L 63/0428; G06F 21/53

(57) ABSTRACT

Systems, methods, apparatus, and articles of manufacture to prevent unauthorized release of information associated with a function as a service are disclosed. A system disclosed herein operates on in-use information. The system includes a function as a service of a service provider that operates on encrypted data. The encrypted data includes encrypted in-use data. The system also includes a trusted execution environment (TEE) to operate within a cloud-based environment of a cloud provider. The function as a service operates on the encrypted data within the TEE, and the TEE protects service provider information from access by the cloud provider. The encrypted in-use data and the service provider information form at least a portion of the in-use information.

### FIELD OF THE DISCLOSURE

This disclosure relates generally to functions as a service, and, more particularly, to systems, methods, apparatus, and articles of manufacture to prevent unauthorized release of information associated with a function as a service.

### BACKGROUND

Users/institutions are increasingly collecting and using very large data sets in support of their business offerings. The ability to process very large data sets is both resource and time consuming and typically outside of the realm of the business using the data. Recent developments to aid such users/institutions in the processing of large data sets include offering a “function as a service” (FaaS) in a cloud based environment. In FaaS, generally, an application is designed to work only when a “function” is requested by a cloud user/customer, thereby allowing the cloud customers to pay for the infrastructure executions on demand. FaaS provides a complete abstraction of servers away from the developer; billing based on consumption and executions; services that are event-driven and instantaneously scalable. FaaS infrastructures allow the assembly of relatively arbitrary workloads, machine learning models, deep neural networks, etc

### BRIEF DESCRIPTION OF THE DRAWINGS

FIG. 1 is a block diagram of an example system to provide a function as a service (FaaS) in a cloud-based environment/platform.

FIG. 2 is a block diagram of the system of FIG. 1 modified in an example manner to prevent unauthorized release of in-use information from an FaaS implemented as a machine learning model service, and to prevent unauthorized release of in-use user data from a user system.

FIG. 3A is a block diagram of an example two-party evaluator of the user system of FIG. 2.

FIG. 3B is a block diagram of an example user data preparer of the user system of FIG. 2.

FIG. 3C is a block diagram of an example machine learning model framework tool of an example machine learning model of FIG. 2.

FIG. 3D is a block diagram of an example homomorphic evaluator of the example machine learning model of FIG. 2.

FIG. 4 is a block diagram of another example modified version of the system of FIG. 1 that includes an example non-cloud based user system, an example cloud based user system, and an example machine model learning service.

FIG. 5 is a block diagram of yet another example modified version of the system of FIG. 1 that includes an example non-cloud based user system, an example cloud based user system, and an example machine model learning service.

FIG. 6 is a block diagram of an example scaled version of the example machine model learning service of FIG. 1.

FIG. 7 is a flowchart representative of machine readable instructions which may be executed to implement the machine learning model service of FIGS. 1, 2, 4 and 5.

FIG. 8 is a flowchart representative of machine readable instructions which may be executed to implement the machine learning model service of FIGS. 1 and 4.

FIG. 9 is a flowchart representative of machine readable instructions which may be executed to implement the machine learning model service of FIGS. 1, and 5.

FIG. 10 is a flowchart representative of machine readable instructions which may be executed to implement the scaled machine learning model service of FIG. 6.

FIG. 11 is a block diagram of an example processing platform structured to execute the instructions of FIGS. 7 to implement a machine learning model service as depicted in claims 1, 2, 4 and 5.

FIG. 12 is a block diagram of an example processing platform structured to execute the instructions of FIG. 8 and/or a portion of the instructions of FIG. 9 to implement a machine learning model service having noise budget control and/or a machine learning model that includes both linear and non-linear operations.

FIG. 13 is a block diagram of an example processing platform 13 to execute a portion of the instructions of FIG. 9 to implement a cloud based user system.

FIG. 14 is a block diagram of an example processing platform structured to execute the instructions of FIG. 10 to implement a supervisor machine learning model service of a scaled machine learning model service.

FIG. 15 is a block diagram of an example software distribution platform to distribute software (e.g., software corresponding to the example computer readable instructions of FIGS. 7, 8, 9 and/or 10) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Cloud-based platforms/environments can be used to provide function-as-a-service (FaaS) services. Such FaaS services are typically operated by service providers and instantiated using the resources/infrastructure available via cloud providers. Users of the FaaS services provide input data to the FaaS services for processing and the FaaS services provide output data generated based on the input data. In many cases, users turn to the FaaS services because the users are not in the business of software development or technology development but rather are data-dependent organizations (e.g., business, banking institution, medical practices, etc.) that require the usage of one or more data processing systems. Thus, the usage of a FaaS services by users is both practical and economically advantageous.

In an FaaS, an application is designed to work when a “function” is requested by a cloud user/customer, thereby allowing the cloud customers to pay for the infrastructure executions on demand. FaaS provides a complete abstraction of servers away from the developer, customer billing based on consumption and executions, and services that are event-driven and instantaneously scalable. Examples of FaaS include AWS Lambda, IBM OpenWhisk, Azure Functions, Iron.io., etc. FaaS infrastructures can allow the assembly of relatively arbitrary workloads, machine learning models, deep neural networks, etc. The usage of such functions can require privacy protection to avoid misuse of user input data.

Generally, the provision and usage of FaaS services involves three entities, which include the user, the FaaS service provider, and the cloud operator. In some examples, the FaaS service provider and the cloud provider can be a same entity such that the provision and usage of some such systems include two entities, the user and the single entity operating as both FaaS service provider and cloud operator. However, in other examples, the FaaS service provider and the cloud provider can be separate entities. As the usage of such FaaS services involves the sharing of information between the entities, the relationship between the three (or two) entities requires a high level of trust as well as the ability to collaborate closely to enable safe access to the FaaS service without risk of exposing in-use user data to any third parties and without risk of exposing intellectual property (also referred to as proprietary information) inherent to the FaaS service offering. Generally, safeguards to prevent unauthorized access to FaaS services are put into place to lessen the risk of breach of the in-use user data supplied to the service and the data results generated by the service and supplied back to the user. A goal of such safeguards is to prevent unauthorized access to the in-use user data and the proprietary information of the three (or two) entities. As used herein, “information” includes at least one or both of the in-use user data and the proprietary information.

User data as used herein refers to “in-use” user data (also generally known as “user data in use”). Such user data is referred to as “in-use” because the user data transmitted between the user system and the FaaS service is in the process of being used to generate output data. “In-use user data” and “user data in use” are equivalent as used in this application.

Likewise, the proprietary information of the FaaS service as used herein refers to “in-use” proprietary information because the proprietary information is in the process of being used by the FaaS service for the purpose of generating output data. “In-use information” is generally also known as “information in use.” “In-use information” and “information in use” are equivalent as used in this application.

Unfortunately, due to the rise in malware, including, for example, ransomware, data breaches of institutions (large and small) are occurring more frequently. As a result, users (institutions), FaaS service providers and cloud providers are searching for improved methods/systems to protect against data breach and/or information breach. Further, as a data/information breach can occur at any point in the FaaS system (e.g., at the user level, at the FaaS service provider and/or at the cloud provider), each of the three (or two) entities has an interest in ensuring that not only their own protective measures are sufficient but that the protective measures of the other parties are sufficient to prevent access via a data/information breach.

The need to take protective measures to prevent unauthorized access to any of the three entities can be heightened in an FaaS system. For example, in some instances, the function provided by the FaaS service is a machine learning model. A rising star in the FaaS services arena, a machine learning model provided as an FaaS service involves not only the transfer of in-use user data to the FaaS service provider but can also include the generation of in-use proprietary information (some of which may qualify for intellectual property protections) by the FaaS service provider. Generally, large data sets are used to train the model of the machine learning model. Training the model with very large data sets results in the generation of a framework, model parameters, coefficients, constants, etc. The in-use user data provided to the machine learning model for processing can also serve to further fine tune the parameters, coefficients, constants, etc. of the model. As the model training can be quite time consuming and as the model itself is the in-use proprietary information of the FaaS service provider, the FaaS service provider has an interest in protecting against unauthorized access to the in-use user data and also against unauthorized access to its in-use proprietary information. As described above and referred to herein, the combination of the in-use user data and the in use proprietary information is referred to as the “in use information” that is to be protected in the interests of the user data institution(s), the FaaS service provider and the cloud provider. Further, information as used herein also refers to “in-use” information for the reasons set forth above.

Example systems, methods, apparatus, and articles of manufacture to prevent the unauthorized release of in-use information from an FaaS service are disclosed herein. In some examples, an FaaS service disclosed herein is implemented using a machine learning model service. However, any function/service can be used to implement the FaaS disclosed herein such that the FaaS is in no way limited to a machine learning model as a service. Disclosed FaaS systems include a combination of homographic encryption (HE) techniques and trusted execution environments (TEE(s)). HE techniques are data encryption techniques in which the encrypted data may be operated on in an HE encrypted state. Thus, HE encrypted data need not be decrypted before being processed. In this way, in-use user data that has been encrypted using an HE technique can be securely supplied by the user to the service provider without concern that a data breach (or other unauthorized usage) at/by the service provider will result in the release of the confidential user data. In addition, the service provider system, and, in some instance, the user system operate within a TEE. As the TEE provides a secure execution environment, concerns that the cloud provider may access the in-use proprietary information of the service provider inherent in the model (or other function) are eliminated and/or greatly reduced.

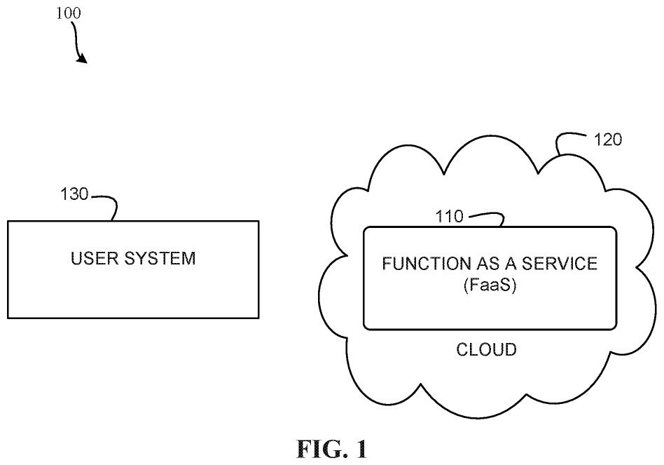

FIG. 1 is a block diagram of an example system 100 including an example FaaS service 110, an example cloud 120 in which to instantiate the FaaS service 110, and an example user system 130 that uses the FaaS service 110, as described above. In some examples, an example service provider that provides the FaaS service and an example cloud provider that provides the cloud 120 are a same entity, and, in some examples, the service provider and the cloud provider are different entities. In some examples, an example user of the user system 130 pays an example service provider of the FaaS service 110 to use the FaaS. In some examples, the user system 130 uses the FaaS 110 installed in the cloud 120 on a pay per use basis or a subscription basis.

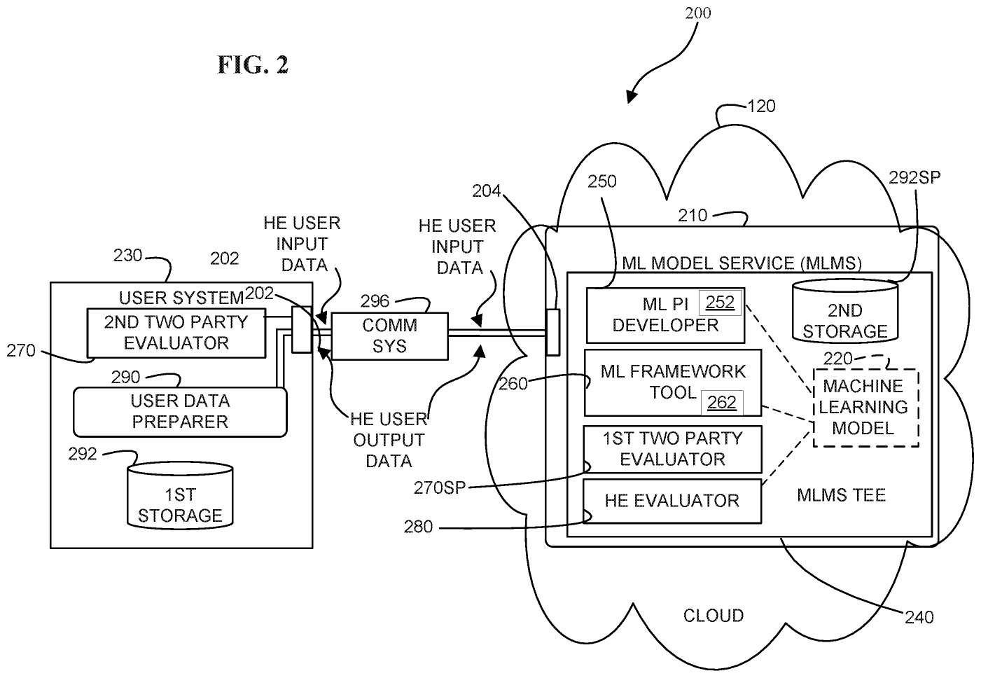

FIG. 2 is block diagram of an example system 200 to provide an example machine learning model service (MLMS) 210 to implement the FaaS 110 of FIG. 1. The example system 200 of FIG. 2 further includes the example cloud 120 of FIG. 1, example transceivers 202, 204, an example machine learning model 220, an example user system 230, an example trusted execution environment (TEE) 240 of the MLMS 210, an example ML proprietary information (PI) developer 250 to develop a set of machine learning proprietary information (ML PI) stored in an example ML PI storage 252, an example machine learning framework tool (ML framework tool) 260, a first example two party evaluator 270SP of the service provider MLMS 210, and an example homomorphic encryption evaluator (HE evaluator) 280. In some examples, the example user system 230 is a non-cloud based system (e.g., deployed in a non-cloud based environment) that includes a second example two party evaluator 270, an example user data preparer 290 (that may be implemented as an HE stack), and an example user database 292. The user system 230 and the MLMS 210 communicate via the wireless and/or wired communication system 296. In some examples, the components of the user system 230 and the components of the MLMS 210 are equipped with interfaces by which the components of the respective systems communicate and/or the MLMS 210 communicates with the user system 230. In some example, such communication is effected with one or more transceivers.

In some examples, in-use user data of the user system 230 is stored in the example user database 292 and then encrypted by the example user data preparer 290 of the user system 230. The user data preparer 290 encrypts the in-use user data with any appropriate homomorphic encryption technique to thereby generate homomorphically encrypted (HE) user input data. In accordance with standard homomorphic encryption techniques, homomorphically encrypted data (e.g., the HE user input data) can be processed (e.g., operated on) without first requiring that the homomorphically encrypted data be decrypted. In some examples, to enable the encryption process, the user data preparer 290 also generates one or more HE evaluation keys, defines a homomorphic encryption /decryption schema, and defines operations that can be performed on the HE user input data. The HE user input data is supplied/transmitted by the user system 230, via the wired and/or wireless communication system 296, to the MLMS 210 for processing by the machine learning model system 220. The communication system 296 can include any number of components/devices (e.g., transmitters, receivers, networks, network hubs, network edge devices, etc.) arranged in any order that enables communication between the user system 230 and the MLMS 210. As the HE user input data is homomorphically encrypted, the risk of access to the data by third parties during transmission is eliminated and/or greatly reduced.

In some examples, the second example two-party evaluator 270 of the example user system 230 encrypts, using a two-party encryption technique, domain parameters associated with the homomorphic encryption technique. In some such examples, the domain parameters (e.g., security guarantees, a homomorphic encryption schema to be used in conjunction with the HE user input data, an evaluation key, etc.) are securely communicated (in the two-party encryption scheme) by the user system 230 to the MLMS TEE 240. In some such examples, the two-party encrypted domain parameters received at the MLMS TEE 240 are decrypted by the first example two party evaluator 270SP (wherein the letters “SP” following the reference number is to indicate that the first two-party evaluator 270SP is associated with the service provider SP of the MLMS 210). In some examples, the first two party evaluator 270SP of the MLMS 210 exchanges any additional information with the two-party evaluator 270 of the user system 230 that is needed to ensure secure communication using the two-party encryption scheme.

In some examples, the machine learning model 220 of FIG. 2 is a linear model and is implemented using the example ML framework tool 260, the example HE evaluator 280, and the ML PI developer 250. In some examples, the ML framework tool 260 (also referred to as an ML platform tool) includes pre-built components/algorithms that are selected from among a number of available pre-built components/algorithms. The selected pre-built components/algorithms provide an ML framework 262 for the machine learning model 220. In some examples, the selected ones of the available pre-built components/algorithms are the pre-built components/algorithms that approximate a real-world system to be modeled by the machine learning model 220.

In some examples, the example HE evaluator 280 implements one or more circuits (e.g., adding circuits, multiplication circuits, etc.) that correspond to the pre-built components/algorithms selected using the example ML framework tool 260. The ML PI developer 250 of the illustrated example generates the ML PI for storage in the ML PI storage 252 by applying, as input, a very large set of training data to the ML framework using the ML framework tool 260 and/or by the HE evaluator 280 to develop a set of weights and/or coefficients. The weights and/or coefficients, when used in conjunction with the ML framework 262 and operations performed by the one or more circuits of the HE evaluator 280, represent the machine learning model 220. In some examples, the machine learning proprietary information can include both the ML framework 262 generated by the framework tool 260, and the weights and/or coefficients (e.g., ML PI) generated by the ML PI developer 250 during the machine learning model training process. In some examples, as the ML PI 252 and the MP LI developer are secured in the MLMS TEE 240, the coefficients/biases need not be encrypted. In some examples, the ML PI to be stored in the ML PI storage 252, and/or the ML framework to be stored in the ML framework storage 262 is/are previously generated using a very large data set. In some such examples, obtaining and applying the very large training data set to the ML framework stored in the ML framework storage 262 is a time and resource intensive process such that the resulting weights and coefficients of the ML PI and the ML framework represent valuable and proprietary information (potentially protected by intellectual property laws) owned by the service provider of the MLMS 210. In some examples, when new data is input by the ML framework tool 260, the weights and/or coefficients generated by the ML PI developer 250 and stored in the ML PI storage 252 can be further adjusted to reflect information that can be inferred from the processing of the input data. In some such examples, the adjusted weights and/or coefficients are stored at the MLMS TEE 240. In some such examples, the storage and contents thereof can be represented by the storage ML PI storage 252, and the ML framework storage and contents thereof can be represented by the ML framework storage 262. In both instances, due to the protection afforded by the MLMS TEE 240, the ML PI of the ML PI storage 252 and the ML framework of the ML framework storage 262 need not be encrypted.

In some examples, HE user input data supplied by the user system 230 to the MLMS 210 is evaluated with the HE evaluator 280 (e.g., the HE user input data is operated on by the HE evaluator 280) to thereby generate HE user output data to be supplied back to the user system 230. In some such examples, the HE evaluator 280 uses domain parameters obtained from an encrypted message transmitted by the example second two party evaluator 270 (of the user system 230). The encrypted message is decrypted by the two-party evaluator 270SP and the domain parameters obtained therefrom are used to process (e.g., operate on) the HE user input data without first decrypting the user data. As the HE user input data remains encrypted when being processed by the HE evaluator 280 of the machine learning model 220, the HE user output data is also homomorphically encrypted. Thus, the HE user input data and the HE user output data are not at risk of being exposed to the service provider of the MLMS 210. The HE user output data is supplied by the MLMS 210 service back to the user system 230 via the communication system 296.

Further, as the example machine learning model 220 is implemented within the example MLMS TEE 240, a cloud provider of the cloud 120 is unable to access the machine learning model 220 (and the intellectual property inherent therein). Additionally, the HE user input and/or HE user output data is protected from the cloud 120 not only by the usage of homomorphic encryption but also by the processing of the HE user input/output data within the MLMS TEE 240. Thus, the cloud provider of the cloud 120 is unable to gain access to either the MLMS TEE 240 or the HE user data.

It is to be understood that the example transceivers 202, 204 can facilitate communication between any components of the user system and any of the components included in the MLMS 210.

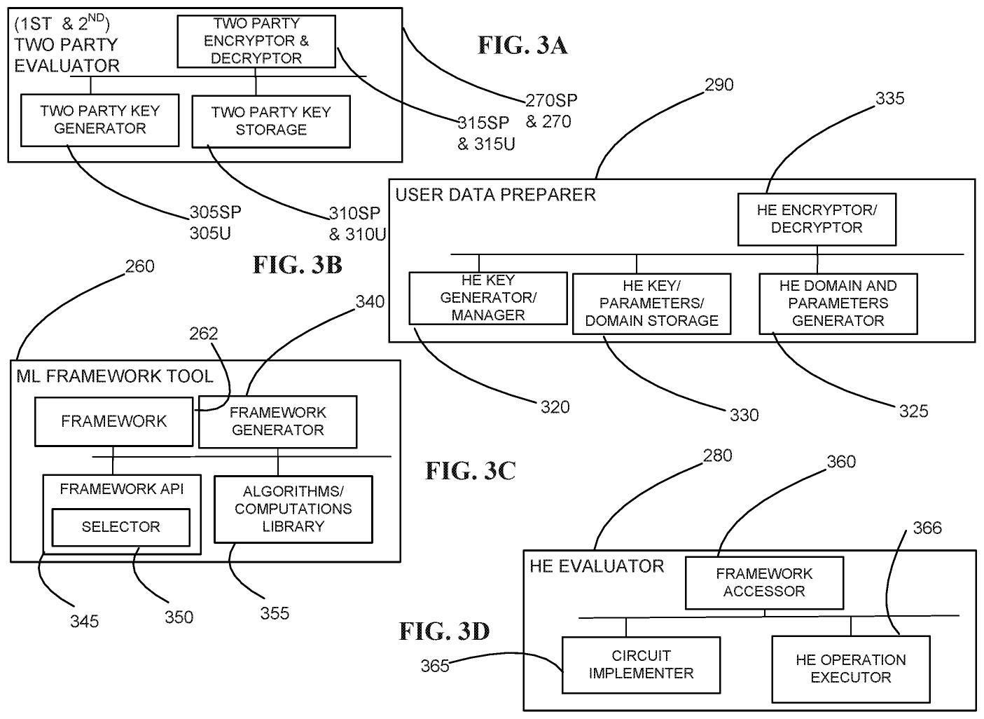

FIG. 3A is a block diagram of the first example two-party evaluator 270SP of the MLMS 210 of FIG. 2 and the second example two-party evaluator 270 of the example user system 230 of FIG. 2. In some examples, the first and second two-party evaluators 270SP, 270 operate to encrypt communications between the user system 230 and the MLMS 210 using a two-way encryption technique. Generally, the first and second two-party evaluators 270SP and 270 can include respective example two party key generators 305SP, 305U to generate a public key(s) and a private key(s), respective example two party key storages 310SP, 310U in which to store the public and private keys, and respective example two party encryptors/decryptors 315SP, 315U to encrypt and decrypt communications (such as the HE parameters to operate on HE encrypted data and any other information needed to securely communicate using the two party encryption scheme) as described above in connection with FIG. 2. The first and second two party evaluators 270SP, 270 may further include any components common to two party evaluators. In addition, the two party evaluators 270, 270SP can include communication interfaces to communicate with any other components/devices included in their respective systems.

FIG. 3B is a block diagram of the example user data preparer 290 of the example user system 230 of FIG. 2. In some examples, the user data preparer 290 includes an example HE key generator/manager 320, an example HE domain and parameters generator 325, an example HE key/parameters/domain storage 330, and an example HE encryptor/decryptor 335. In some examples, the HE key generator/manager 320 generates an HE key that enables operations to be performed on the HE user input data. The HE domain and parameters generator 325 generates parameters and/or a domain/schema for use in determining how the HE in-use user data is arranged. The HE key(s) and the HE domain and parameters can be stored in the HE key/parameters/domain storage 330. In some examples, the HE encryptor/decryptor 335 uses one or more of the HE key, parameters and/or domain/schema to encrypt and/or decrypt the in-use user data stored in the user database 292 (see FIG. 2). In some examples, the two party encryptor/decryptor 315U (see FIG. 3A) uses a two party encryption scheme to encrypt the HE key(s), parameters, and/or domain/schema for secure transmission from the user system 230 to the MLMS TEE 240 (see FIG. 2) for use by the example HE evaluator 280. As described further below, in some such examples, the HE evaluator 280 (see FIG. 2 and FIG. 3D) uses one or more of the HE key, the HE domain and/or the HE parameters to operate on the HE user input data without decrypting the HE user input data. In addition, the user data preparer 290 can include communication interfaces to communicate with any other components/devices included in the user system. In some examples, the user system 230 includes a first storage 292 and the example MLMS 210 includes a second storage 292SP (wherein the term “SP” is used to indicate that the second storage 292SP is associated with the service provider e.g., the MLMS 210). In some examples, any and/or all of the components of the user system 230 can access information and/or store information in the first storage 292. In some examples, the first storage 292 represents multiples storages to store varying kinds of information (e.g., user data, HE user input data, HE user output data, program/computer software/instructions, etc.). Likewise, the second storage 292SP can represent multiples storages or a single storage. In some examples, the service provider storage 292SP can store varying types of information and is accessible to the components of the MLMS TEE 240.

FIG. 3C is a block diagram of the example ML framework tool 260 of the example MLMS 210 of FIG. 2. In some examples, the ML framework tool generator 260 includes an example framework generator 340, an example framework application user interface (API) 345 having an example selector 350, and an example algorithms/computations library 355. In some examples, the framework API 345 allows an operator/administrator of the MLMS 210 to select, via the selector 350, one or more of the algorithms/computations stored in the algorithms/computations library 355. In some examples, the framework generator tool 340 can select the algorithms/computations. In some examples, the algorithms/computations are selected based on a real-world system that the machine learning model 220 is to represent. Thus, in some examples, an administrator/operator of the MLMS 210 supplies information about the real-world system to be modeled for use in selecting the algorithms/operations. The framework generator 340 generates the framework based on the selected algorithms/computations. In addition, ML framework tool 260 can include communication interfaces to communicate with any other components/devices included in the MLMS system.

FIG. 3D is a block diagram of the example HE evaluator 280 of the example MLMS 210 of FIG. 2. In some examples, the HE evaluator 280 includes an example framework accessor 360, an example circuit implementer 365, and an example HE operation executor 366. In some examples, the framework accessor 360 accesses the ML framework tool 260 to obtain the ML framework 262 and the circuit implementer 365 uses the ML framework to implement/build circuits based on the operations of the algorithms included in the ML framework. In some examples, the circuit implementer 365 implements the circuits in the HE operation executor 366. The HE operation executor 366 then operates on the HE user input data with the circuits. In some examples, the HE operation executor 366 also uses the HE domain and parameters and the HE key generated by the user data preparer 290 and transmitted to the MLMS (as described above in connection with FIG. 2) to operate on the HE user data.

The first and second example two-party evaluators 270SP, 270, the example user data preparer 290, the example ML framework tool 260, and the example HE evaluator 280 of FIGS. 3A, 3B, 3C, and 3D, respectively, can include more or fewer components than those illustrated. Further, any available tools designed to perform the operations of the example first and second two-party evaluators 270SP, 270, the example user data preparer 290, the example ML framework tool 260, and the example HE evaluator 280 of FIGS. 3A, 3B, 3C, and 3D, respectively, can be used. For example, the user data preparer 290 may be implemented as an HE stack of operations and the HE key generator/manager 320 can be implemented as an element that is separate from the user data preparer 290. Additionally, it is to be understood that the components included in the MLMS TEE 210 are configured to communicate via, for example, one or more interfaces as needed to perform the operations described with respect to FIGS. 3B, 3C, 3D, and FIG. 2. Further, the components at the user system 230 are configured to communicate, via for example, one or more interfaces, as needed to perform the operations performed at the user system 230 as described with respect to FIG. 2, FIG. 3A, and FIG. 3B.

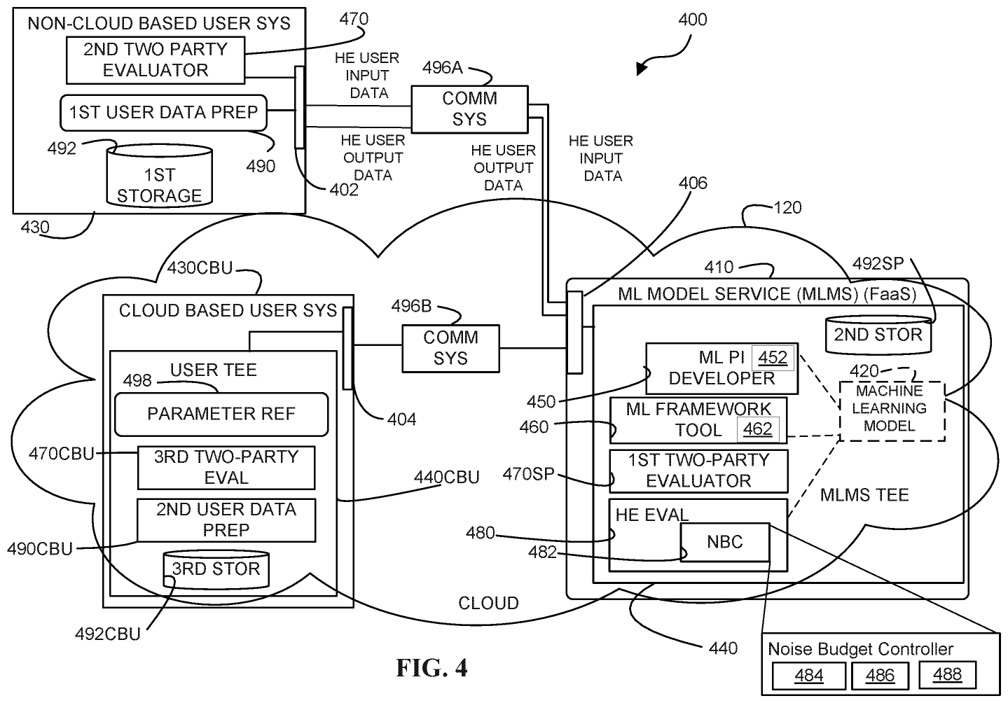

FIG. 4 is a block diagram of an example system 400 to provide an example machine learning model service (MLMS) 410 to implement the FaaS 110 of FIG. 1. The example system 400 of FIG. 4 includes the example cloud 120 (also shown in FIG. 1), example transceivers 402, 404, 406, an example user system 430, an example machine learning model 420 implemented within an example trusted execution environment (TEE) 440 of the MLMS (FaaS) 410, an example set of machine learning model (MLM) coefficients and/or weights 452, an example machine learning framework tool (ML framework tool) 460, an example first two party evaluator 470SP, and an example homomorphic encryption evaluator (HE evaluator) 480 with a noise budget controller 482. In some examples, the example user system 430 is a non-cloud based system (e.g., deployed in a non-cloud based environment) that includes a second example two-party evaluator 470, an example user database 492CBU, and a first example user data preparer 490. The user system 430 and the MLMS (FaaS) 410 communicate via a wireless and/or wired communication system 496A.

In some examples, the system 400 further includes a cloud based user system 430CBU (wherein the letters “CBU” after a reference number are to differentiate the Cloud Based User system (and/or components thereof) from the non-cloud based user system 430 (and/or components thereof) instantiated in the cloud 120. The cloud based user system 430CBU includes an example user TEE 440CBU, within which operate an example parameter refresher 498, a third example two party evaluator 470CBU, and a second example user data preparer 490CBU. The cloud-based user system 430CBU communicates with the MLMS (FaaS) 410 via a wired and/or wireless communication system 496B.

In some examples, the user system 430 (and/or components therein) operates in the manner described with respect to the user system 230 of FIG. 2 to provide, to the MLMS (FaaS) 410, the HE user input data and any information needed by the MLMS (FaaS) 410 to operate on the HE user input data. Similarly, at least some of the blocks/components of the cloud based user system 430CBU operate in a manner similar to that described with respect to the user system 230 of FIG. 2. Operations performed by the cloud based user system 430CBU that differ from operations performed by the non-cloud based user system 230 of FIG. 2 are described below. In some examples, the example MLMS (FaaS) 410 of FIG. 4 generally operates in the manner described with respect to the MLMS 210 of FIG. 2. Operations performed by the MLMS (FaaS) 410 of FIG. 4 that differ from the operations performed by the MLMS 210 of FIG. 2 are described in below.

In some examples, the example non-cloud based user system 430 includes a first storage 492, the example MLMS (FaaS) 410 includes a second storage 492SP, and the example cloud based user system 430CBU includes a third storage 492CBU. In some examples, any and/or all of the components of the non-cloud based user system 430 can access information and/or store information in the first storage 492. In some examples, the first storage 492 represents multiple storages to store varying kinds of information (e.g., user data, HE user input data, HE user output data, program/computer software/instructions, etc.). Likewise, the second storage 492SP and/or the third storage 492CBU can represent multiple storages or a single storage. In the illustrated example, the second storage 492SP can store varying types of information and is accessible to the components of the MLMS TEE 440, and the third storage 492CBU can store varying types of information and is accessible to the components of the user TEE 440CBU.

In some examples, the HE user input data received at the MLMS (FaaS) 410 from the non-cloud based user system 430 is processed by the machine learning model 420 in a manner similar to the way in which the MLMS 210 operates to process HE user input data. As described with respect to the machine learning model 220 of FIG. 2, the machine learning model 420 is implemented with the example ML framework tool 460 (and the example ML framework storage 462) , the example HE evaluator 480, and the ML PI developer 450 (and the example ML PI storage 452). Further, the components of the user system 430 and the components of the MLMS (FaaS) 410 can be equipped with interfaces (or any other communication means) by which the components of the respective systems communicate and/or the MLMS 210 communicates with the user system 230. In some example, such communication is effected with one or more transceivers.

In some examples, the example HE evaluator 480 of FIG. 4 includes an example noise budget controller 482 for use in operating on the HE user input data. In some examples, the noise budge controller NBC 482 includes an example counter 484 to count a number of nested operations/computations (e.g., multiplication operations) performed by the HE evaluator 480, an example comparator 486 to compare the number of nested operations with a noise budget threshold, and an example trigger 488 to cause the results/output of a most recently performed set of operations (e.g., HE intermediate user data) to be supplied to the cloud based user system 430CBU when the noise budget threshold is satisfied. In some examples, the results/output of the most recently performed set of operations are referred to as HE intermediate user data. In some examples, when the threshold is satisfied the trigger 488 causes the counter to be reset to zero, and the HE evaluator 480 temporarily halts the performance of further operations/computations on the HE user input data. In some such examples, if additional operations/computations were to continue to be performed on the HE user input data by the HE evaluator 480 after the threshold had been satisfied, the data content of the HE user input data may be lost due to noise that is inherently introduced by the nested operations/computations.

To ensure that the data content of the HE in-use user data is not lost among noise, one or more of the ML PI coefficients and/or weights generated by the ML PI developer 450 used by the HE evaluator 480 are refreshed at the cloud based user system 430CBU by the example parameter refresher 498. To avoid exposing the HE intermediate in-use user data to the MLMS TEE 440 in an unencrypted form, the output of the most recently performed operations/computations are supplied to the user cloud-based system 430CBU while still in an HE encrypted format.

In some examples, to communicate information needed to process the HE intermediate in-use user data generated at the MLMS (FaaS) 410, the user cloud-based system 430 CBU includes the third example two-party evaluator 470CBU. In some such examples, the third two party evaluator 470CBU is equipped with a private and public key of the user and is further equipped with the authority to use the private and public key for two-way communications with the MLMS (FaaS) 410 In some examples, the private and/or public key(s) needed to initiate two-party encrypted communication between the MLMS (FaaS) 410 and the cloud based user system 430CBU are exchanged between the third two-party evaluator 470CBU of the cloud based user system 430CBU and the first two party evaluator 470SP of the MLMS (FaaS) 410. In some examples, the first two party evaluator 470SP transmits information about the parameters to be refreshed and any other information needed by the user data preparer 494CBU of the cloud based user system 430CBU. In some examples, the third two-party evaluator 470CBU of the user cloud-based system 430 CBU decrypts the parameters to be refreshed.

As described above, the output of the most recently performed set of operations (e.g., the HE intermediate user data) is transmitted from the MLMS (FaaS) 410 (via the example second communication system 496B) to the user cloud based system 430CBU in an HE encrypted format. In some such examples, the example second user data preparer 490CBU of the example cloud based user system 430CBU decrypts the HE intermediate user data. In some such examples, information such as the HE domain/schema, HE key(s), and other HE information can be transmitted between the MLMS (FaaS) 410 and the cloud based user system 430CBU via communications between the first and the third two-party evaluators 470SP and 470CBU or such information may instead already be stored at the cloud based user system 430CBU. When the HE intermediate in-use user data is decrypted, the example parameter refresher 498CBU uses the supplied parameters and the decrypted intermediate in-use user data to generate new parameters (also referred to as refreshed parameters) and to scale the intermediate user data. Scaling of the intermediate in-use user data (referred to hereinafter as intermediate output data) is performed to eliminate the influence of noise on the in-use user data (e.g., the amount of noise in the in-use user data caused by the processing that occurred at the MLMS is reduced to zero or to an amount at or below some other threshold level). In some examples, the parameters are refreshed based on unencrypted, intermediate in-use user data because such operations cannot be performed on homomorphically encrypted data. Thus, the instantiation of the user TEE 440CBU allows the parameters to be refreshed based on unencrypted intermediate in-use user data so that the data need not be exposed to the MLMS (FaaS) 410 in an unencrypted state.

The refreshed parameters (and any other information needed by the machine learning model 420 to continue operating on the HE intermediate user data) are encrypted by the third example two-party evaluator 470CBU and communicated to the first example two-party evaluator 470SP.

In addition, the intermediate scaled user output data is re-encrypted by the user data preparer 490CBU operating in a manner similar to that described with respect to the user data preparer 290 of FIG. 2 and FIG. 3B. In some examples, a revised HE schema and/or other HE parameters needed to operate on the homomorphically encrypted data are provided to the third two-party evaluator 470CBU for two party encryption and subsequent transmission to the MLMS TEE 440. In some examples, the HE re-scaled intermediate output data transmitted from the user cloud-based system 430 CBU back to the MLMS (FaaS) 410 is further processed by the example HE evaluator 480. In some examples, the refreshed parameters supplied to the MLMS (FaaS) 410 are used to update the corresponding parameters (coefficients/weights) of the ML PI stored in the ML PI storage 452 and thereby revise the machine learning model 420 as needed to perform a next set of operations. Thus, the corresponding parameters and any additional HE schema parameters, etc., are used by the ML framework tool 460, the ML framework and/or the HE evaluator 480 of the machine learning model 420 to further process the HE intermediate user data. The HE evaluator 480 again performs a number of nested operations/computations on the HE intermediate in-use user data until the noise budget threshold is again satisfied at which time, the results/output of the most recently executed set of HE evaluator operations are again supplied as HE intermediate in-use user data (as well as any supplemental data such as the current set of HE parameters) to the cloud based user system 430CBU, in the manner described above, for rescaling and refreshing.

When the noise budget threshold is not satisfied, the example machine learning model 420 determines whether there is additional HE user input data to be operated on, and, if so, continues to perform nested operations on the data. In either event, when all of the HE user input data has been operated on using the machine learning model 420 of the MLMS 440, the resulting HE encrypted user output data (i.e., the HE user output data) is transmitted by the MLMS (FaaS) 410 to the non-cloud based user system 430. Thus, in the system 400, the MLMS TEE 440 shields the machine learning model 420 (including the ML IP developer 250, the ML PI stored in the ML PI storage 452, the ML framework tool 460, the ML framework stored in the ML framework storage 462, and the HE evaluator 480) from access by the cloud 120 and from access by the user cloud based system 430CBU and the non-cloud based user system 430. Additionally, the cloud based user system 430 CBU and the non-cloud based user system 430 use homomorphic encryption to shield the in-use user data from the cloud 120 and the MLMS (FaaS) 410. Accordingly, the system 400 uses the TEES 440 and 430CBU, two-party encrypted communication, and HE encrypted in-use user data to prevent unauthorized release of information (either in-use user data or in-use proprietary information) from the respective owners of the information.

It is to be understood that the example transceivers 402, 404, 406 can facilitate communication between any components of the non-cloud based user system 430, the cloud based user system 430CBU, the MLMS 410 in the manner represented in FIG. 4.

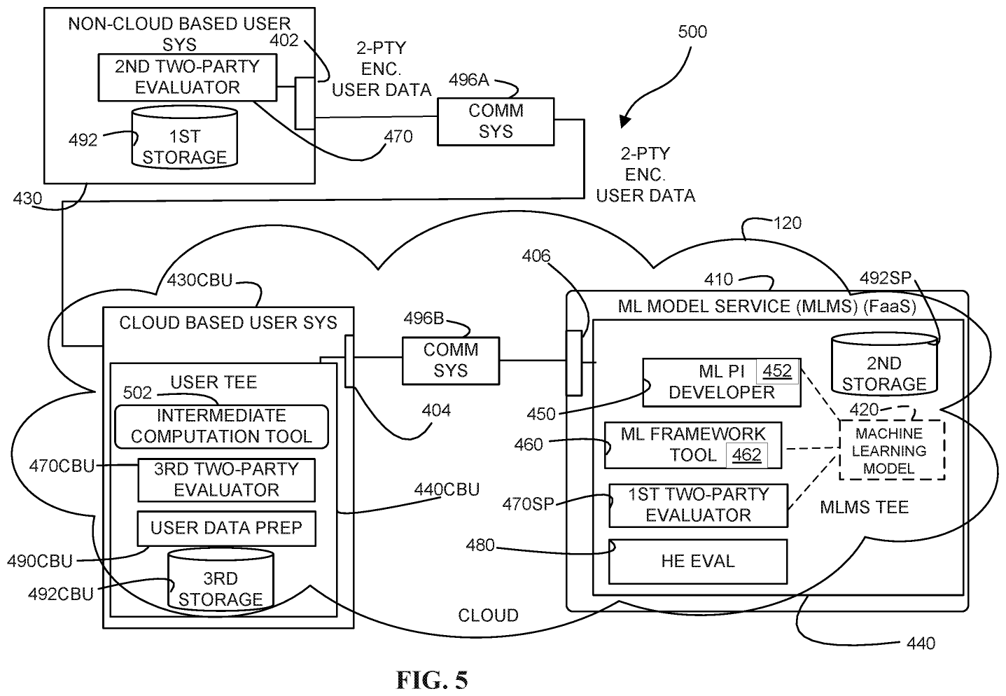

FIG. 5 is a block diagram of an example system 500 to provide an example machine learning model service (MLMS) 510 to implement the FaaS 110 of FIG. 1. In some examples, the system 500 includes the system 400 of FIG. 4, but modified to replace the example parameter refresher 498 with an example intermediate computation tool 502. In addition, some of the components of the system 500 operate in a modified manner as compared to the corresponding components of system 400 described below. Thus, in some examples, the system 500 of FIG. 5 includes the example machine learning model (FaaS) 410 implemented by (i) the example ML PI developer 450 having coefficients and weights stored in the example ML PI storage 452, (ii) the example ML framework tool 460 and the ML framework stored in the ML framework storage 462, and (iii) the example HE evaluator 480. In some examples, the example first two party evaluator 270SP is also implemented within the MLMS TEE 440. In some examples, the system 500 also includes example transceivers 402, 404, 406, and the example non-cloud based user system 430 having the example two-party evaluator 470 and the example user database 492. As illustrated, the non-cloud based user system 430 of FIG. 5 is not equipped (though it could be) with a user data preparer (unlike the non-cloud based user system 430 of FIG. 4 which includes the example first data preparer 492). The non-cloud based user system 430 communicates with the example cloud based user system 430 CBU, also of the system 500. In some examples, the cloud based user system instantiates the user TEE 440CBU in which the example intermediate computation tool 502, the third example two party evaluator and the example user data preparer 490CBU securely operate. In some examples, the components of the non-cloud based user system 430, the components of the MLMS (FaaS) 410, the components of the cloud based user system 430CBU are equipped with interfaces by which the components of the respective systems communicate and/or the MLMS (FaaS) 410 communicates with the user system 430 and/or the cloud based user system 430CBU. In some example, such communication can be effected with one or more transceivers.

In the example system 500, the user input data is supplied from the example non-cloud based user system 430 to the user TEE 430CBU implemented within the cloud based user system 430CBU. In some such examples, the user input data is communicated between the second example two party evaluator 470 and the third example two party evaluator 470CBU in a two-party encrypted format. At the cloud based user TEE 440CBU, the in-use user data is decrypted from the two party encryption format by the third two-party evaluator 470CBU and then re-encrypted by the example user data preparer 490CBU. Note that, in FIG. 4 the user data preparer 490CBU is referred to as the “second user data preparer 490CBU” to distinguish the user data preparer 490CBU from the first user data preparer 490 of the non-cloud based user system 430. As the first user data preparer 490 is not present in the system 500 of FIG. 5, the user data preparer 490CBU is not referred to as the “second user data preparer” in the context of FIG. 5. The user data preparer 490CBU uses a homomorphic encryption technique to encrypt the user input data to thereby form HE user input data. In some such examples, the processing burden of homomorphically encrypting the in-use user data set is performed at the cloud based user system 430CBU instead of the non-cloud based user system 430 as is the case in the system 400 of FIG. 4.

The HE user input data is supplied by the cloud based user system 430CBU to the example MLMS (FaaS) 410 where it is operated on by the machine learning model 420 within the MLMS TEE 440. In some examples, the machine learning model 420 generates HE intermediate in-use user data to be supplied by the MLMS (FaaS) 410 to the example intermediate computation tool 502 of the user TEE 440CBU. In some such examples, the intermediate computation tool 502 performs one or more intermediate operations (which may include any type of operations/computations, e.g., parameter refresh, data re-scaling, etc.) as described with respect to the cloud based user system 400 of FIG. 4. In some examples, the HE intermediate in-use user data may be transferred back and forth between the cloud based user system CBU and the MLMS (FaaS) 410 as many times as needed to generate an HE user output data set (e.g., a set of encrypted output data that has been fully processed by the machine learning model 420 and the intermediate computation tool 502) that is to be transmitted to the non-cloud based user system 430. In some such examples, the HE user output data is supplied by the MLMS TEE 440 to the user data preparer 490CBU of the cloud based user system 430CBU. The user data preparer 490CBU decrypts the HE user output data from the homomorphic encryption format and the example third two-party evaluator 470CBU re-encrypts the in-use user data using a two-party encryption technique. In some such examples, the output in-use user data in the two-party encryption format is transmitted to the non-cloud based user system 430 for usage thereat.

Thus, in the example system 500 of FIG. 5, the infrastructure needed to homomorphically encrypt the data is moved from the non-cloud based user system 430 to the cloud based user system 430CBU thereby lessening the processing burden of the non-cloud based user system 430. Using the cloud based user system 430CBU to perform the homomorphic encryption of the in-use user data can be a more efficient and cost saving usage of processing resources for the user of the MLMS (FaaS) service 410. Further, by using the MLMS TEE 440, the user TEE 440CBU, and the two party encryption technique, the in-use user data and the in-use proprietary information of the provider of the MLMS (FaaS) 410 are protected against unauthorized usage/access to the in-use user data and in-use proprietary information of the machine learning model.

As described above with respect to the system 400 of FIG. 4 and the system 500 of FIG. 5, in some examples, the example MLMS (FaaS) 410 and the example cloud based user system 430CBU communicate HE intermediate user data. As described above, the example system 400 includes the communication of HE intermediate in-use user data to enable the parameters of the machine learning model 420 to be refreshed so that noise can be removed from the data. In some examples, exchange of HE intermediate in-use user data occurs in the system 500 between the example MLMS 400 and the example cloud based user system 430CBU so that both linear and non-linear operations associated with the machine learning model 420 can be used to operate on the user data. In some such examples, linear operations (which can be successfully performed on homomorphically encrypted data) are performed on the HE in-use user data using the machine learning model 420 of the MLMS TEE 440 and non-linear operations are performed at the user TEE 440CBU of the cloud based user system 430CBU in an unencrypted format.

When the example machine learning model 420 of the system 500 includes both linear and non-linear computations, the linear operations are performed by the machine learning model 420 at the MLMS TEE 440 on the HE user input data. In some such examples, the first two-party evaluator 470SP of the MLMS (FaaS) 410 encrypts the functional form (e.g., the ML framework) of the machine learning model 420 and provides the encrypted ML framework to the example third two party evaluator 470CBU of the cloud based user TEE 440CBU. In some such examples, the first two-party evaluator 470SP of the MLMS TEE 440 transmits the ML framework to the cloud based user system by encrypting (and then transmitting) a netlist of the ML framework to be used by the intermediate computation tool 502 of the user TEE 440CBU as described further below.

In some examples, the two-party encryption technique is implemented using Yao's Garbled Circuit. When Yao's Garbled Circuit encryption technique is used, the cloud-based user system 430CBU is able to access the portions of the ML framework needed to perform non-linear operations on the unencrypted in-use user data but is not able to access the garbled model coefficients and/or weights/biases that constitute the ML PI developed by the ML PI developer 450. In some such examples, the ML framework stored in the ML framework storage 462 does not constitute propriety information (or does not constitute confidential proprietary information) to the service provider such that sharing the ML framework with the user cloud based system 430CBU does not cause security concerns for the MLMS (FaaS) 410, whereas the ML PI coefficients/weights, etc., stored in the ML PI storage 452 do constitute propriety information (or confidential proprietary information) and remain secure. In some such examples, the intermediate computation tool 502 is able to use the garbled model coefficients and/or weights/biases of the machine learning model 420 to perform computations on the HE intermediate in-use user data without needing to be able to access the garbled information in a non-garbled form.

In some such examples, the example third two party evaluator 470CBU decrypts the ML framework and extracts the garbled model coefficients/weights/biases, the user data preparer 490CBU of the cloud based user system 730CBU decrypts the HE intermediate in-use user data supplied by the MLMS TEE 440, and the example intermediate computation tool 502 performs one or more non-linear computations/operations on the unencrypted intermediate user data. The unencrypted in-use user data is then re-encrypted by the in-use user data preparer 490CBU and transmitted back to the MLMS (FaaS) 410 for further processing, as needed based on the machine learning model 420.

When the linear and non-linear operations have been performed such that the HE user output data has been generated, the resulting HE user output data is transmitted by the MLMS (FaaS) 410 to the non-cloud based user system 430 via the cloud-based user system 430CBU in the manner described above.

It is to be understood that the example transceivers 402, 404, 406 of FIG. 5 can facilitate communication between any components of the non-cloud based user system 430, the cloud based user system 430CBU, the MLMS 410, in the manner represented in FIG. 5.

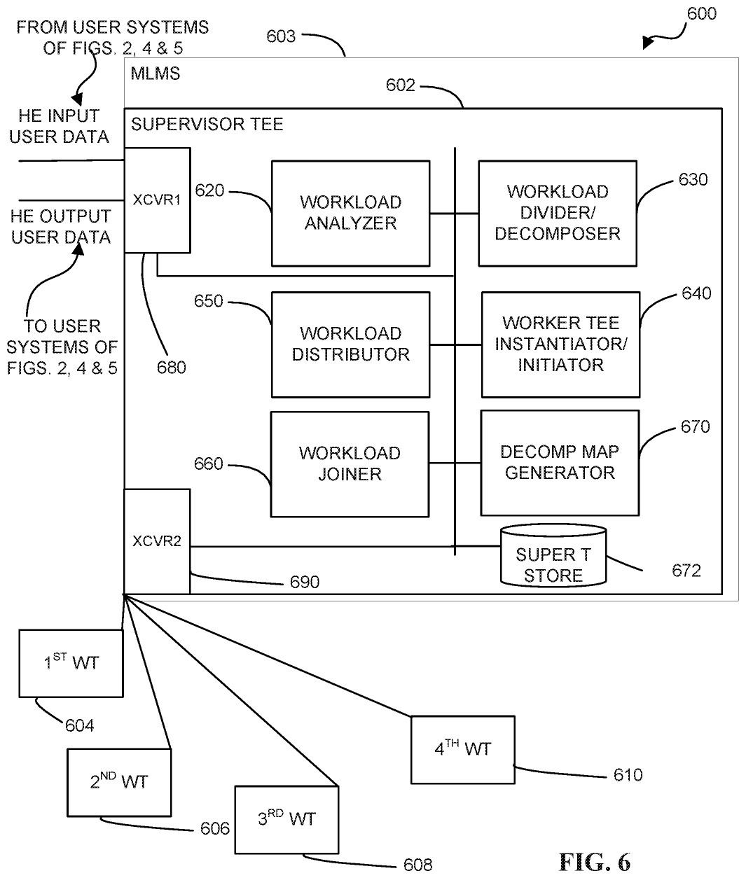

FIG. 6 is a block diagram of an example system 600 in which a machine learning model to implement the FaaS is provided in a scaled environment. In some examples, the system 600 includes an example supervisor TEE 602 instantiated by an example MLMS 603, an example first worker TEE 604, an example second worker TEE 606, an example third worker TEE 608, and an example fourth worker TEE 610 (also referred as the four worker TEEs). In some examples, the supervisor TEE 602 includes an example workload analyzer 620, an example workload divider/decomposer 630, an example TEE instantiator/initiator 640, an example workload distributor 650, an example workload joiner 660, an example decomposition map generator 670, and an example supervisor TEE storage 672. In some examples, the supervisor TEE 602 communicates with one or more user systems (e.g., any of the user systems 100, 200, 400 and/or 500 of FIGS. 1, 2, 4, and 5) via a first transceiver (XCVR1) 680 and communicates with any of the four worker TEEs 604, 606, 608, and 610 via a second transceiver (XCVR2) 690. In some such examples, the supervisor TEE 602 receives information identifying a machine learning workload from any of the user systems 100, 200, 400 and/or 500 of FIGS. 1, 2, 4, and 5, and/or from an operator of the supervisor TEE 602. The workload analyzer 620 of the supervisor TEE 602 analyzes the machine learning workload to determine whether the machine learning workload has any inherent data parallelism (e.g., matrix multiplications can be performed in parallel). If so, the workload 620 analyzer determines a number of TEEs needed to execute the machine learning model in a parallel fashion. If not, the supervisor TEE 602 may notify the user system (see FIG. 1, 2, 4 and/or 5) of the machine learning model that an error has occurred. In some examples, the supervisor TEE 672 may store any information used/processed/transmitted to/received at the super TEE 672.

When the workload analyzer 620 determines that data parallelism is available, the workload analyzer 620 provides information about the parallelism of the workload and the workload itself to the workload divider/decomposer 630. The workload divider/decomposer 630 divides the workload into a number of chunks that can be implemented within the execution footprint of a TEE. The workload divider/decomposer supplies the number of chunks to the example worker TEE instantiator/initiator 640. The worker TEE instantiator/initiator 640 causes a number of TEEs equal to the number of chunks to be instantiated. In some examples, the number of chunks is four and, thus, the number of TEEs to be instantiated is four. In some examples, the example workload distributor 650 distributes respective portions/chunks of the machine learning model to respective ones of the four worker TEEs 604, 606, 608, 610 for execution thereat. The four worker TEEs 604, 606, 608, 610 return HE output data to the supervisor TEE 602 and the example workload joiner 660 joins the HE output results and causes the HE output results to be transmitted via the XCVR1 680 to the user system. Although four TEEs are illustrated in this example, any number of TEEs could be used. Further, any number of supervisor TEEs can be used. The HE output data/results are transmitted to the user system in an HE encrypted format. In addition, the example decomposition map generator 670 generates a map identifying how the machine learning model was decomposed and causes the map to be supplied to the user system, via the XCVR1 680, for use in determining how to arrange the output data received from the example supervisor TEE 602.

While example manners of implementing machine learning models as a service system 100 of FIG. 1 is illustrated in FIG. 2 and FIGS. 3A-D one or more of the elements, processes and/or devices illustrated in FIG. 2 and FIGS. 3A-D may be combined, divided, re-arranged, omitted, eliminated and/or implemented in any other way. Further, the example transceiver 202, 204, the example user system 230, the example second two party evaluator 270, the example user data prepare 290, the example user database 292, the example communication system 296, the example cloud 120, the example MLMS 210, the example MLMS TEE 240, the example ML PI developer 250, the example ML PI storage 252, the example ML framework tool 260, the example ML framework storage 262, the example first two party evaluator 270SP, the example HE evaluator 280, the example machine learning model 220, the example two party key generator 305SP, 305U, the example two party key storage 310SP, 310U, example HE key generator/manager 320, the example HE domain and parameters generator 325, the example HE keys/parameters/domain storage 330, the example framework generator 340, the example framework API 345, the example selector 350, the example framework 262, and the example algorithms/computations library 355, the example framework accessor 360, the example circuit implementer 365, the example HE operation executor 366, and /or more generally, the example machine learning model as a service system 200 of FIG. 2 and the example components of the example system 200 depicted in FIGS. 3A, 3B, 3C, and/or 3D may be implemented by hardware, software, firmware and/or any combination of hardware, software and/or firmware. Thus, for example, any of the example transceivers 202, 204, the example user system 230, the example second two party evaluator 270, the example user data prepare 290, the example user database 292, the example communication system 296, the example cloud 120, the example MLMS 210, the example MLMS TEE 240, the example ML PI developer 250, the example ML PI storage 252, the example ML framework tool 260, the example ML framework storage 262, the example first two party evaluator 270SP, the example HE evaluator 280, the example machine learning model 220, the example two party key generator 305SP, 305U, the example two party key storage 310SP, 310U, example HE key generator/manager 320, the example HE domain and parameters generator 325, the example HE keys/parameters/domain storage 330, the example framework generator 340, the example framework API 345, the example selector 350, the example framework 262, and the example algorithms/computations library 355, the example framework accessor 360, the example circuit implementer 365, the example HE operation executor 366, and /or more generally, the example machine learning model as a service system 200 of FIG. 2 and the example components of the example system 200 depicted in FIGS. 3A, 3B, 3C, and/or 3D could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example the example transceivers 202, 204, user system 230, the example second two party evaluator 270, the example user data prepare 290, the example user database 292, the example communication system 296, the example cloud 120, the example MLMS 210, the example MLMS TEE 240, the example ML PI developer 250, the example ML PI storage 252, the example ML framework tool 260, the example ML framework storage 262, the example first two party evaluator 270SP, the example HE evaluator 280, the example machine learning model 220 the example two party key generator 305SP, 305U, the example two party key storage 310SP, 310U, example HE key generator/manager 320, the example HE domain and parameters generator 325, the example HE keys/parameters/domain storage 330, the example framework generator 340, the example framework API 345, the example selector 350, the example framework 262, the example algorithms/computations library 355, the example framework accessor 360, the example circuit implementer 365, the example HE operation executor 366, and /or more generally, the example machine learning model as a service system 200 of FIG. 2 and the example components of the example system 200 depicted in FIGS. 3A, 3B, 3C, and/or 3D is/are hereby expressly defined to include a non-transitory computer readable storage device or storage disk such as a memory, a digital versatile disk (DVD), a compact disk (CD), a Blu-ray disk, etc. including the software and/or firmware. Further still, the example system 200 of FIG. 2 including the components illustrated in FIGS. 3A, 3B, 3C, and 3D may include one or more elements, processes and/or devices in addition to, or instead of, those illustrated in FIG. 2 and FIGS. 3A, 3B, 3C, and 3D, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

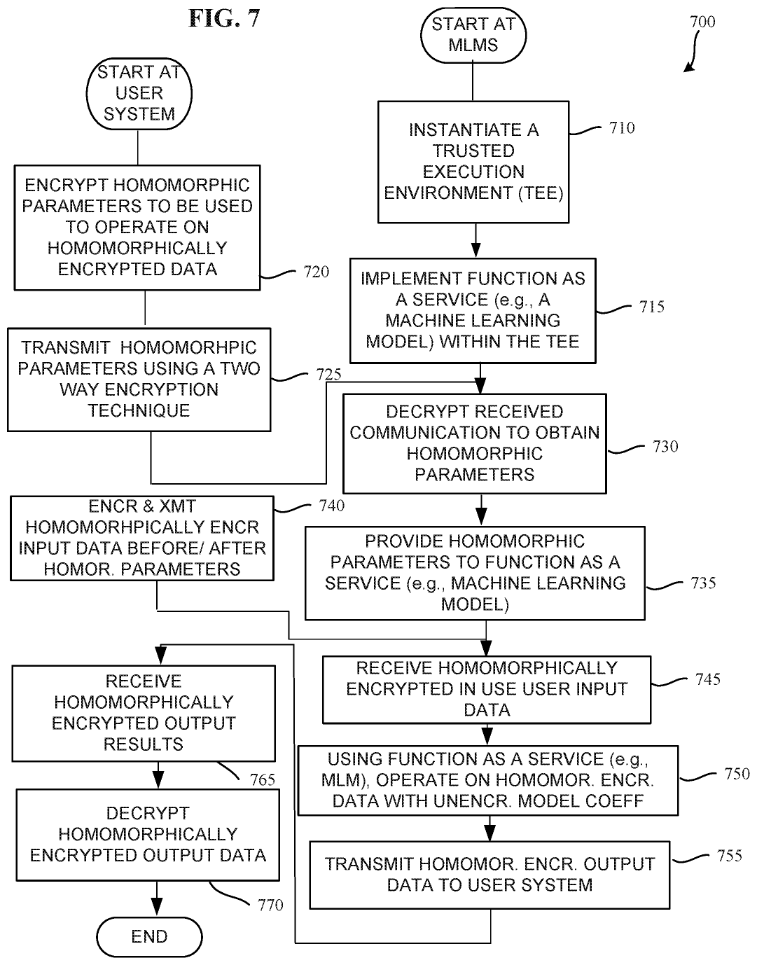

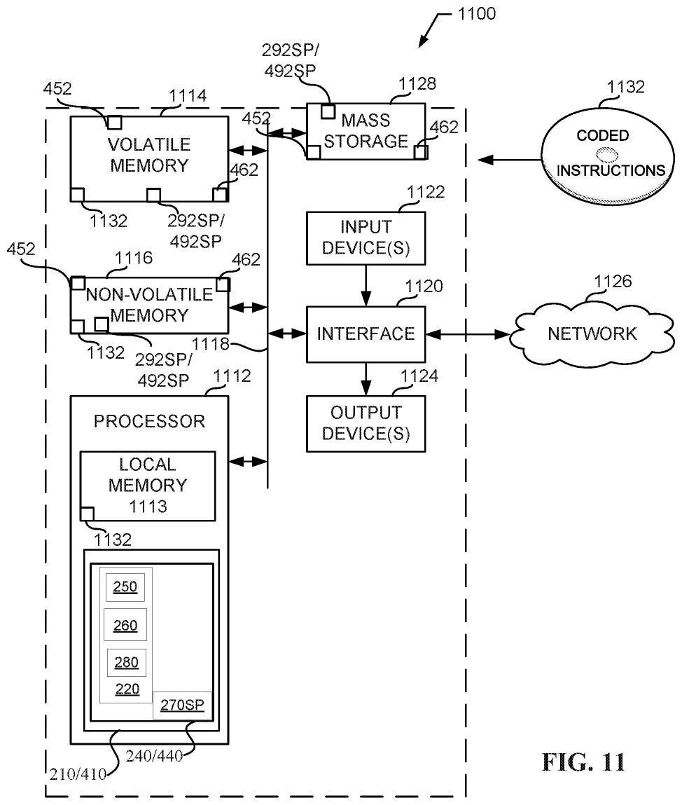

A flowchart representative of example hardware logic, machine readable instructions, hardware implemented state machines, and/or any combination thereof for implementing the MLMS 210 of FIG. 2 is shown in FIG. 7. The machine readable instructions may be one or more executable programs or portion(s) of an executable program for execution by a computer processor and/or processor circuitry, such as the processor 1112 shown in the example processor platform 1100 discussed below in connection with FIG. 11. The program may be embodied in software stored on a non-transitory computer readable storage medium such as a CD-ROM, a floppy disk, a hard drive, a DVD, a Blu-ray disk, or a memory associated with the processor 1112, but the entire program and/or parts thereof could alternatively be executed by a device other than the processor 1112 and/or embodied in firmware or dedicated hardware. Further, although the example program is described with reference to the flowchart illustrated in FIG. 7, many other methods of implementing the example MLMS 210 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

While example manners of implementing machine learning models as a service system 100 of FIG. 1 is illustrated in FIG. 4 and in FIG. 5 one or more of the elements, processes and/or devices illustrated in FIG. 4 and FIG. 5 may be combined, divided, re-arranged, omitted, eliminated and/or implemented in any other way. Further, the example transceivers 402, 404, 406, the example non-cloud based user system 430, the example second two party evaluator 470, the example first user data prepare 490, the example user database (also referred as the first storage) 492, the example communication system 496A, the example cloud 120, the example MLMS (FaaS) 410, the example MLMS TEE 440, the example ML PI developer 450, the example ML PI storage 452, the example ML framework tool 460, the example ML framework storage 462, the example first two party evaluator 470SP, the example HE evaluator 480, the example noise budget controller 482, the example counter 484, the example comparator 486, the example trigger 488, the example machine learning model 220, the example cloud based user system 430CBU, the example user TEE 440CBU, the example parameters refresher 498, the example third two party evaluator 470CBU, the example second user data preparer 490CBU, the example communication system 496B, the example intermediate computation tool 502 and /or more generally, the example machine learning model as a service system 400 of FIG. 4 and the example machine learning model as a service system 500 of FIG. 5 may be implemented by hardware, software, firmware and/or any combination of hardware, software and/or firmware. Thus, for example, any of the example the example transceivers 402, 404, 406, the example non-cloud based user system 430, the example second two party evaluator 470, the example first user data prepare 490, the example user database (also referred to as the example third storage) 492, the example communication system 496A, the example cloud 120, the example MLMS (FaaS) 410, the example MLMS TEE 440, the example ML PI developer 450, the example ML PI (storage and contents thereof) 452, the example ML framework tool 460, the example ML framework storage (and contents thereof) 462, the example first two party evaluator 470SP, the example HE evaluator 480, the example noise budget controller 482, the example counter 484, the example comparator 486, the example trigger 488, the example machine learning model 220, the example cloud based user system 430CBU, the example user TEE 440CBU, the example parameters refresher 498, the example third two party evaluator 470CBU, the example second user data preparer 490CBU, the example communication system 496B, the example intermediate computation tool 502 and /or more generally, the example machine learning model as a service system 400 of FIG. 4 and the example machine learning model as a service system 500 of FIG. 5 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example transceivers 402, 404, 406, the example non-cloud based user system 430, the example second two party evaluator 470, the example first user data prepare 490, the example user database 492, the example communication system 496A, the example cloud 120, the example MLMS (FaaS) 410, the example MLMS TEE 440, the example ML PI developer 450, the example ML PI storage (and contents thereof) 452, the example ML framework tool 460, the example ML framework storage (and contents thereof) 462, the example first two party evaluator 470SP, the example HE evaluator 480, the example noise budget controller 482, the example counter 484, the example comparator 486, the example trigger 488, the example machine learning model 220, the example cloud based user system 430CBU, the example user TEE 440CBU, the example parameters refresher 498, the example third two party evaluator 470CBU, the example second user data preparer 490CBU, the example communication system 496B, and/or the example intermediate computation tool 502 of FIGS. 4 and 5 is/are hereby expressly defined to include a non-transitory computer readable storage device or storage disk such as a memory, a digital versatile disk (DVD), a compact disk (CD), a Blu-ray disk, etc. including the software and/or firmware. Further still, the example system 400 of FIG. 4 and the example system 500 of FIG. 5 may include one or more elements, processes and/or devices in addition to, or instead of, those illustrated in FIGS. 4 and 5, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

While an example manner of implementing a scaled machine learning model as a service 600 is illustrated in FIG. 6 one or more of the elements, processes and/or devices illustrated in FIG. 6 may be combined, divided, re-arranged, omitted, eliminated and/or implemented in any other way. Further, the example MLMS 603, the example supervisor TEE 602, the example first worker TEE 604, the example second worker TEE 606, the example third worker TEE 608, and the example fourth worker TEE 610 (also referred as the four worker TEEs), the example workload analyzer 620, the example workload divider/decomposer 630, the example TEE instantiator/initiator 640, the example workload distributor 650, the example workload joiner 660, and the example decomposition map generator 670, the example, the example user systems of FIGS. 1, 2, 4, and 5, the example first transceiver (XCVR1) 680, the example second transceiver (XCVR2) 690 and/or more generally the example scaled machine learning model as a service system 600 of FIG. 6 may be implemented by hardware, software, firmware and/or any combination of hardware, software and/or firmware. Thus, for example, any of the example MLMS 603, the example supervisor TEE 602, the example first worker TEE 604, the example second worker TEE 606, the example third worker TEE 608, and the example fourth worker TEE 610 (also referred as the four worker TEEs), the example workload analyzer 620, the example workload divider/decomposer 630, the example TEE instantiator/initiator 640, the example workload distributor 650, the example workload joiner 660, and the example decomposition map generator 670, the example, the example user systems of FIGS. 1, 2, 4, and 5, the example first transceiver (XCVR1) 680, the example second transceiver (XCVR2) 690 and/or more generally the example scaled machine learning model as a service system 600 of FIG. 6 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example MLMS 603, the example supervisor TEE 602, the example first worker TEE 604, the example second worker TEE 606, the example third worker TEE 608, and the example fourth worker TEE 610 (also referred as the four worker TEEs), the example workload analyzer 620, the example workload divider/decomposer 630, the example TEE instantiator/initiator 640, the example workload distributor 650, the example workload joiner 660, and the example decomposition map generator 670, the example, first transceiver (XCVR1) 680, the example second transceiver (XCVR2) 690, the example user systems of FIGS. 1, 2, 4, and 5, and/or more generally the example scaled machine learning model as a service system 600 of FIG. 6 is/are hereby expressly defined to include a non-transitory computer readable storage device or storage disk such as a memory, a digital versatile disk (DVD), a compact disk (CD), a Blu-ray disk, etc. including the software and/or firmware. Further still, the example system 600 of FIG. 6 may include one or more elements, processes and/or devices in addition to, or instead of, those illustrated in FIG. 6, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

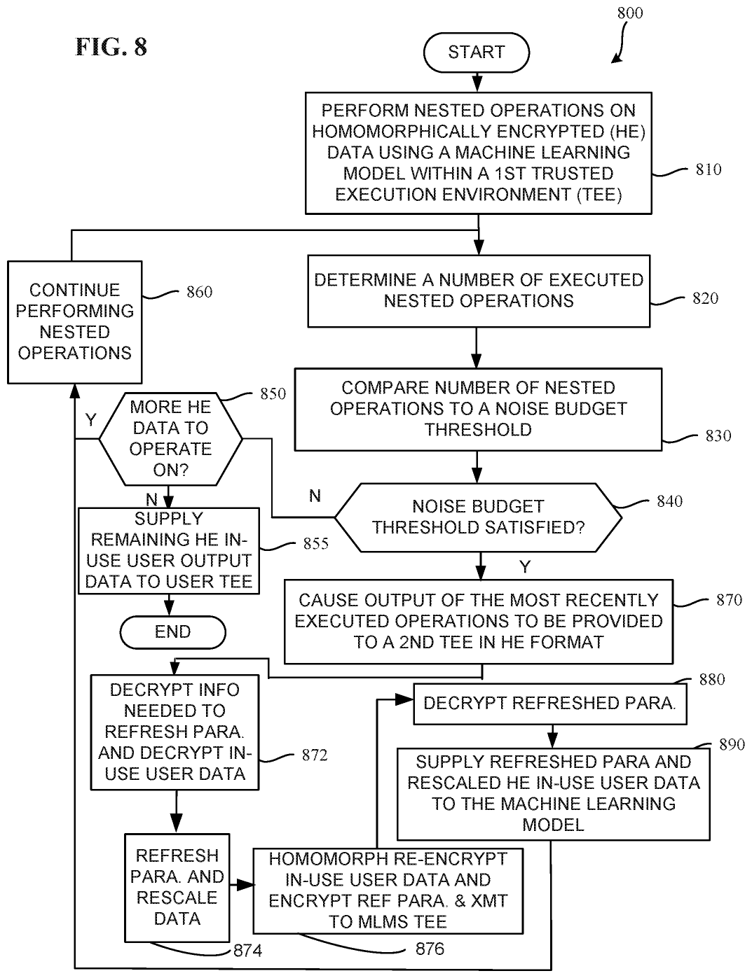

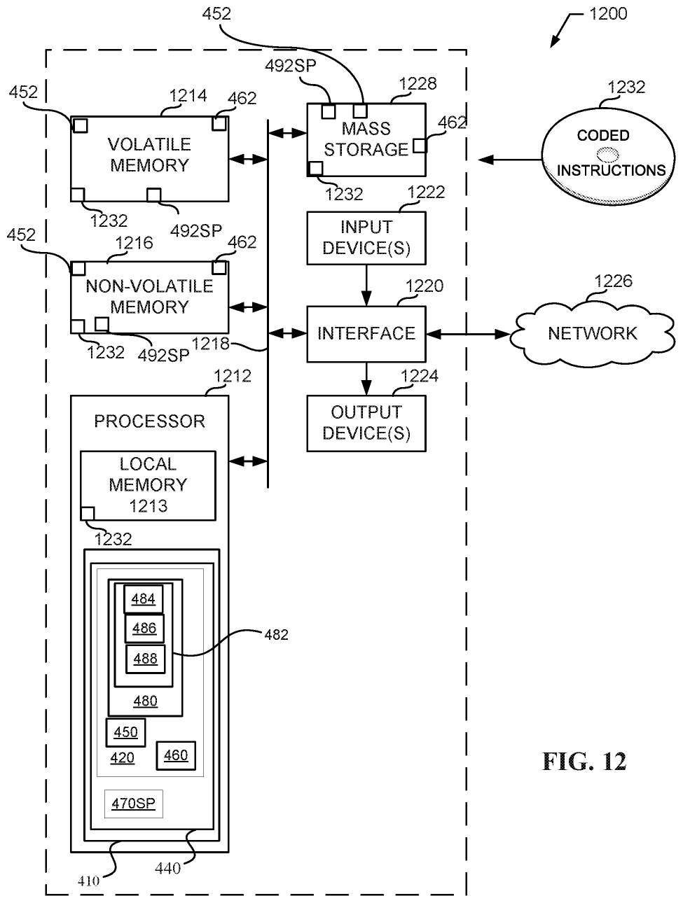

A flowchart representative of example hardware logic, machine readable instructions, hardware implemented state machines, and/or any combination thereof for implementing the MLMS (FaaS) 410 of FIG. 4 is shown in FIG. 8. The machine readable instructions may be one or more executable programs or portion(s) of an executable program for execution by a computer processor and/or processor circuitry, such as the processor 1212 shown in the example processor platform 1200 discussed below in connection with FIG. 12. The program(s) may be embodied in software stored on a non-transitory computer readable storage medium such as a CD-ROM, a floppy disk, a hard drive, a DVD, a Blu-ray disk, or a memory associated with the processor 1212, but the entire program and/or parts thereof could alternatively be executed by a device other than the processor 1212 and/or embodied in firmware or dedicated hardware. Further, although the example program is described with reference to the flowchart illustrated in FIG. 8 many other methods of implementing the example MLMS (FaaS) 410 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

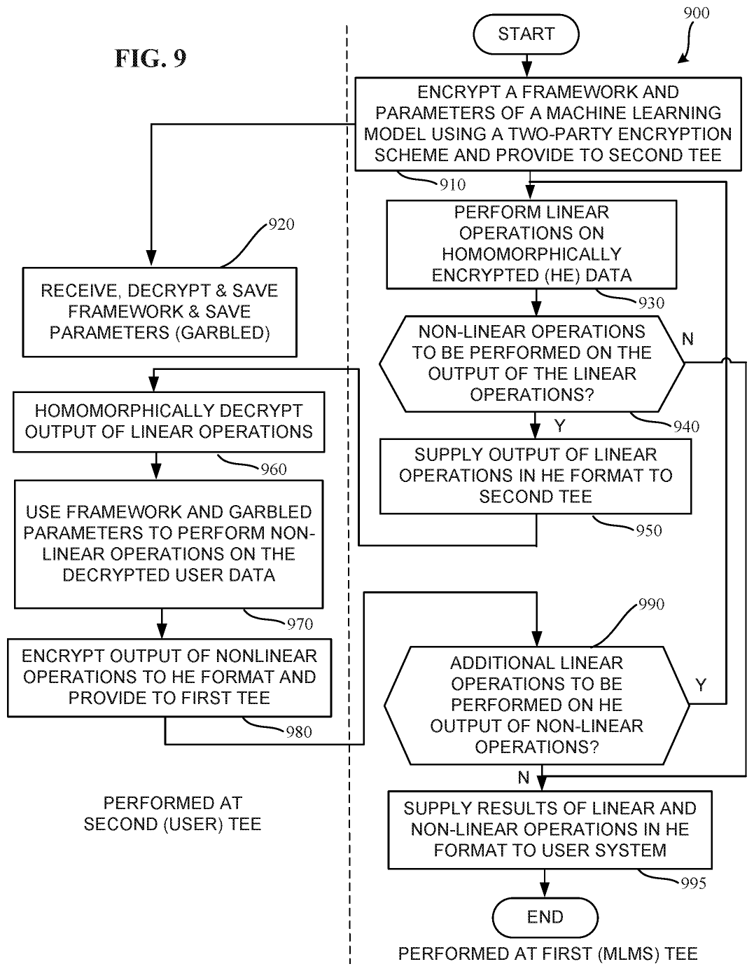

A flowchart representative of example hardware logic, machine readable instructions, hardware implemented state machines, and/or any combination thereof for implementing the MLMS (FaaS) 410 of FIG. 5 is shown in FIG. 9 (to the right of the dashed line). The machine readable instructions indicating as being performed by the MLMS TEE 440 of FIG. 5, for example, may be one or more executable programs or portion(s) of an executable program for execution by a computer processor and/or processor circuitry, such as the processor 1212 shown in the example processor platform 1200 discussed below in connection with FIG. 12. The program may be embodied in software stored on a non-transitory computer readable storage medium such as a CD-ROM, a floppy disk, a hard drive, a DVD, a Blu-ray disk, or a memory associated with the processor 1212, but the entire program and/or parts thereof could alternatively be executed by a device other than the processor 1212 and/or embodied in firmware or dedicated hardware. Further, although the example program is described with reference to the flowchart illustrated in FIG. 9, many other methods of implementing the example cloud based MLMS (FaaS) 410 of FIG. 5 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

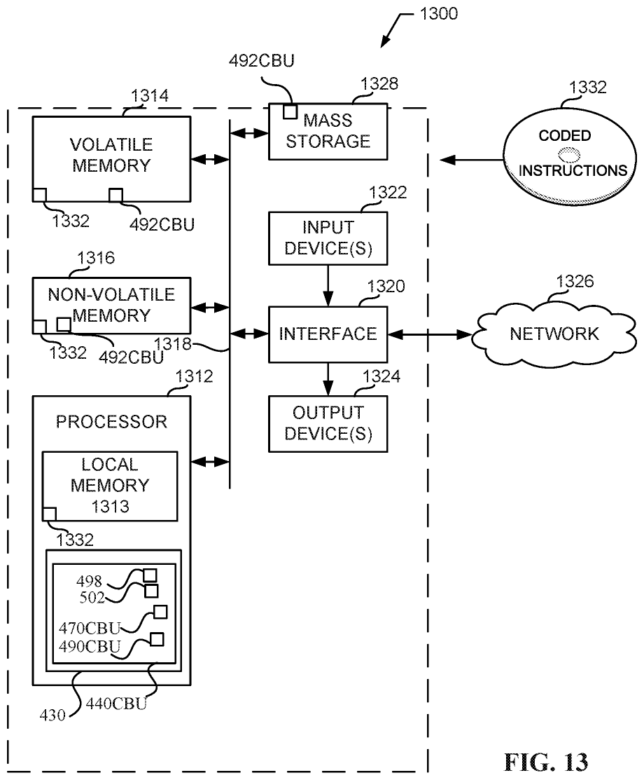

The flowchart representative of example hardware logic, machine readable instructions, hardware implemented state machines, and/or any combination thereof for implementing the user TEE 440CBU of FIG. 5 is also shown in FIG. 9 (to the left of the dashed line). The machine readable instructions indicating as being performed by the user TEE 440CBU of FIG. 5, for example, may be one or more executable programs or portion(s) of an executable program for execution by a computer processor and/or processor circuitry, such as the processor 1312 shown in the example processor platform 1300 discussed below in connection with FIG. 13. The program may be embodied in software stored on a non-transitory computer readable storage medium such as a CD-ROM, a floppy disk, a hard drive, a DVD, a Blu-ray disk, or a memory associated with the processor 1312, but the entire program and/or parts thereof could alternatively be executed by a device other than the processor 1312 and/or embodied in firmware or dedicated hardware. Further, although the example program is described with reference to the flowchart illustrated in FIG. 9, many other methods of implementing the example cloud based user TEE 440CBU of FIG. 5 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

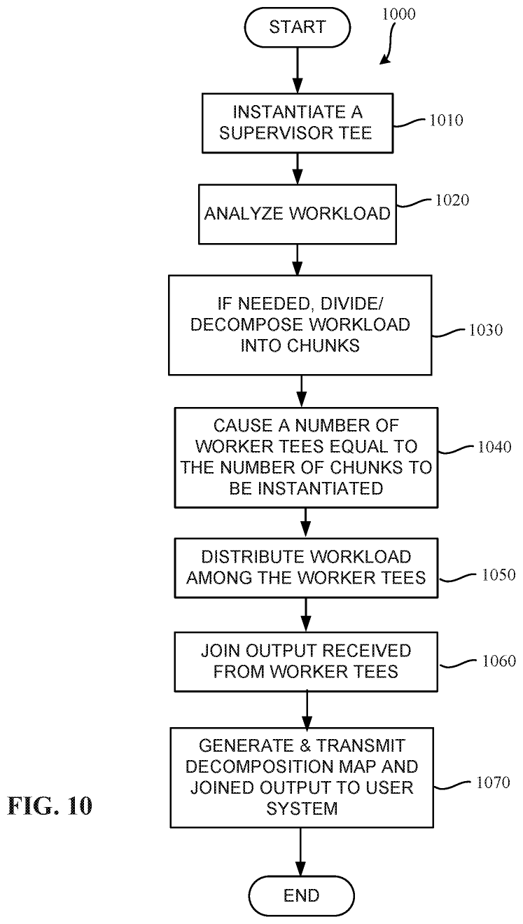

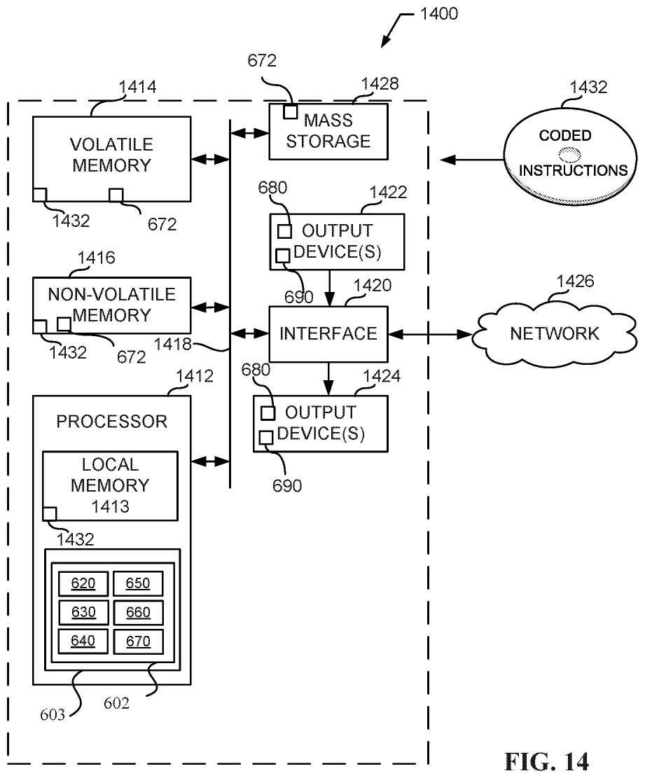

A flowchart representative of example hardware logic, machine readable instructions, hardware implemented state machines, and/or any combination thereof for implementing the MLMS 603 of FIG. 6 is shown in FIG. 10. The machine readable instructions may be one or more executable programs or portion(s) of an executable program for execution by a computer processor and/or processor circuitry, such as the processor 1412 shown in the example processor platform 1400 discussed below in connection with FIG. 14. The program may be embodied in software stored on a non-transitory computer readable storage medium such as a CD-ROM, a floppy disk, a hard drive, a DVD, a Blu-ray disk, or a memory associated with the processor 1412, but the entire program and/or parts thereof could alternatively be executed by a device other than the processor 1412 and/or embodied in firmware or dedicated hardware. Further, although the example program is described with reference to the flowchart illustrated in FIG. 10, many other methods of implementing the example MLMS 603 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 7, 8, 9, and 10 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

The program 700 of FIG. 7 is an example implementation of at least portions of the example systems 200, 400, and/or 500 of FIGS. 2, 4, and 5, respectively, and includes block 710 at which any of the example MLMS 210 of FIG. 2, the example MLMS (FaaS) 410 of FIG. 4 and/or the example MLMS (FaaS) 410 of FIG. 5 instantiate a trusted execution environment (e.g., any of the MLMS TEE 240 of FIG. 2, the MLMS TEE 440 of FIG. 4 and/or the MLMS TEE 440 of FIG. 5). At block 715, any of the example MLMS 210 of FIG. 2, the example MLMS (FaaS) 410 of FIG. 4 and/or the example MLMS (FaaS) 410 of FIG. 5 implement a machine learning model within the TEE, as described above with respect to FIGS. 2, 4, and 5.

At block 720, the example user system 230 of FIG. 2, 430 of FIG. 4, and/or 430CBU of FIG. 5 encrypt homomorphic parameters to be used by the corresponding MLMS (210/410) to operate on the homomorphically encrypted data without having to first decrypt the homomorphically encrypted data. At block 725, the user system 230/430/430CBU transmits the homomorphic parameters (which have been encrypted using a two way encryption technique) to the corresponding MLMS 240/440.

At block 730, a two party evaluator (e.g., the first two party evaluator 270SP of FIG. 2 and/or the first two party evaluator 470SP of FIGS. 4 and 5) decrypts the communication containing the encrypted homomorphic parameters to obtain the unencrypted homomorphic encryption parameters in the manner described with respect to FIGS. 2, 4 and 5. As described above, the communication can be encrypted in a two-party encryption format and received from any of the non-cloud based user system (e.g., the non-cloud based user system 430 of FIGS. 2, 4 and/or FIG. 5 and/or the cloud based user system 430CBU of FIG. 4 and FIG. 5). In addition, at block 735, the homomorphic parameters (also referred to herein as homomorphic parameters) are supplied to the corresponding one of the example machine learning model 220 of FIG. 2, or the machine learning model 420 of FIG. 4 and FIG. 5.

At block 740, the user data preparer 290 of FIG. 2, the first user data preparer 490 of FIG. 4, the second user data preparer 490CBU of FIG. 4, and/or the user data preparer of FIG. 5, respectively, homomorphically encrypt the user input data and transmit the homomorphically encrypted input data to the respective one of the example machine learning models 240/440 (see FIG. 2 and FIG. 4).

At block 745, the example MLMS TEE (e.g., any of the MLMS TEE 240 of FIG. 2, the MLMS TEE 440 of FIG. 4 and/or the MLMS TEE 440 of FIG. 5) receives the homomorphically encrypted input data as described above. At block 750, the appropriate one of the machine learning model 240/440 uses the homomorphic parameters and the set of model decrypted/unencrypted coefficients to operate on the homomorphically encrypted input data and thereby generate homomorphically encrypted output data, as described above with respect to FIGS. 2, 4, and 5. At block 755, the example MLMS TEE transmits the example homomorphically encrypted output data to the appropriate one of the example user system 210/410/410CBU as described above with respect to FIGS. 2, 4 and 5.

At block 765, the appropriate one of the example user system 210/410/410CBU of FIGS. 2, 4 and 5, receive the homomorphically encrypted output data and, at block 770, and the appropriate one of the user data preparer 290 of FIG. 1, the first user data preparer 440 or the second data preparer 440CBU of FIG. 4, and the user data preparer 440CBU of FIG. 5 decrypts the homomorphically encrypted output data. Thereafter, the program 700 ends.

The program 800 of FIG. 8 includes block 810 at which the example MLMS TEE (e.g., the MLMS TEE 440 of FIG. 4) implements a machine learning model (e.g., the machine learning model 440 of FIG. 4) to perform nested operations on HE data (e.g., HE user input data/in-use user input data) as described above with respect to FIG. 4. At block 820, a counter (e.g., the example counter 484 of FIG. 4) determines/counts a number of executed nested operations as described above with respect to FIG. 4. At block 830, a comparator (e.g., the example comparator 486 of FIG. 4) compares the number of nested operations to a noise budget threshold, as described with respect to FIG. 4 above. When it is determined, at block 840, that the noise budget threshold is satisfied, a trigger (e.g., the trigger 488) causes the output of a most recently executed set of operations (e.g., HE intermediate in-use user data) to be provided to a second TEE (e.g., the example user TEE 440CBU of FIG. 4) (block 870), as also described above with respect to FIG. 4. In some examples, (also at block 870), any other information needed by the user TEE 440CBU to generate the refreshed parameters is encrypted by the first two party evaluator 470SP of the MLMS TEE 440 and provided to the third two party evaluator 470CBU of the user TEE 440CBU for decryption. At block 872, the example second user data preparer 490CBU decrypts the HE in-use user data supplied by the MLMS TEE 440 (e.g., the results of the most recently executed set of operations) and the third two party evaluator 470CBU decrypts any non-HE data supplied with the HE in-use user data, as also described above with respect to FIG. 4.

At block 874, the example parameter refresher 498 operates on the decrypted in-use user data with any additional information supplied via the third two party evaluator 470CBU to refresh parameters of the machine learning model and to re-scale the (in-use) user input data as described above with respect to FIG. 4. At block 876, the refreshed parameters are re-encrypted by the third two-party evaluator 490CBU using the two-party encryption technique and the re-scaled in-use user data is homomorphically re-encrypted by the second user data preparer 490CBU. In addition, at block 876, both the rescaled in-use user data and the refreshed parameters are transmitted back to the MLMS TEE 440. After the refreshed parameters are decrypted (block 880) by the first two party evaluator 470SP of the MLMS TEE 440, the refreshed parameters and the re-scaled HE intermediate in-use user data are supplied to the machine learning model 420 (of the MLMS (FaaS) Tee 440) (block 890) after which the program returns to block 860. At block 860, the machine learning model 420 again/continues to perform nested/nesting computations on the HE in-use user data. Thereafter the program returns to block 820.

At block 840, when the noise budget threshold is not satisfied, the machine learning model 420 of FIG. 4 determines whether there is additional HE in-use user data to be operated on as described above with respect to FIG. 4. When there is additional HE in-use user data to be processed, the machine learning model 440 continues to perform nested/nesting operations at block 860 and thereafter the program returns to block 820. When (at block 850) the machine learning model 420 determines there is no additional HE in-use user data to be operated on, any remaining HE in-use user output data is supplied back to the user TEE 440CBU (block 855) and the program 800 ends.

The program 900 of FIG. 9 can be used to implement the example system 500 of FIG. 5. The program 900 can include block 910 at which one or more of the example components of the example MLMS TEE 440 of FIG. 5 encrypt a machine learning model framework and parameters of a machine learning model 420 (see FIG. 5) using a two party encryption scheme in the manner described above with respect to FIG. 5. In addition, the MLMS TEE 440 supplies the encrypted information to a second (user) tee (e.g., the cloud based user TEE 440CBU) in the manner described above with respect to FIG. 5. In some examples, the machine learning model framework and parameters of the machine learning model are encrypted using Yao's Garbled Circuit encryption technique such that the machine learning framework can be decrypted at the cloud based user TEE 440CBU while the parameters remain garbled. In some examples, the encrypted machine learning framework of the machine learning model are received at the cloud based user TEE 440CBU, and decrypted by the example third two party evaluator 470CBU (see FIG. 5) and saved at the user TEE 440CBU with the garbled parameters of the machine learning model 420 for usage by the intermediate computation tool 502 (block 920).

At the first TEE, (e.g., the example MLMS TEE 440 of the MLMS (FaaS) 410) the machine learning model 420 performs linear operations on HE user input data provided by the example second (user) TEE (e.g., the cloud based user TEE 440CBU) in the manner described with respect to FIG. 5 (block 930). In some such examples, the HE user input data is received at the user TEE 440 CBU from the non-cloud based user system 430 in a two way encrypted format, decrypted by the example third two-party evaluator 470CBU of the user TEE 440CBU, and subsequently homomorphically encrypted by the example user data preparer 490CBU of the user TEE 440 CBU.

In some examples, the example machine learning model 420 determines whether there are non-linear operations are to be performed on the output of the linear operations (block 940). When non-linear operations are to be performed (based on the machine learning model 420), the example HE evaluator of the MLMS TEE 440 causes the HE data generated as an output of the linear operations (also referred to as HE intermediate user data) to be supplied to the example user TEE 440CBU in the manner described above with respect to FIG. 5 (block 950). At the user TEE 440CBU, the example user data preparer 490CBU decrypts the HE intermediate in-use user data and supplies the de-crypted data to the example intermediate computation 470CBU. As described above with respect to FIG. 5, the intermediate computation tool 470CBU uses the framework and garbled parameters to perform non-linear operations on the decrypted in-use user data (block 970).

In some examples, the output of the non-linear operations are re-encrypted by the user data preparer 490CBU and then supplied by the user TEE 440CBU to the MLMS TEE 440 (block 980) in the manner described above with respect to the FIG. 5. In some examples, at the MLMS TEE 440, the machine learning model 420 determines whether there are more/additional linear operations to be performed on the output of the non-linear operations (e.g., the HE intermediate user data) supplied by the user TEE 440CBU (block 990). When there are additional/more linear operations to be performed, the program 900 returns to block 930 and the operations subsequent thereto as described above. When there are no additional/more linear operations to be performed, the results of the linear and non-linear operations are supplied in an HE form to the example non-cloud base system 430 by way of the example cloud based user TEE 430CBU in the manner described above with respect to FIG. 5 (block 995). Thereafter, the program 900 ends.

The program 1000 of FIG. 10 can be used to implement the example system 600 of FIG. 6. The program 1000 can include block 1010 at which an example MLMS (e.g., the MLMS 603 of FIG. 6) instantiates an example supervisor TEE 602. An example analyzer 620 (FIG. 6) receives and analyzes an example workload supplied to the MLMS by a user of the MLMS or an administrator of the MLMS (block 1020), as described above with respect to FIG. 6. If needed (e.g., if the workload is too large to be executed by a machine learning model implemented in a single TEE), the example workload divider/decomposer 630 divides/decomposes the workload into a set of chunks, each of which can processed within a single TEE (block 1030), as described above with respect to FIG. 6. In addition, the example worker TEE instantiator/initiates 640 instantiates a number of worker TEEs equal to the number of chunks (block 1040). In some examples the worker TEE instantiator/initiates 640 initiates a process by which the worker TEE as instantiated using the MLMS 603. The example workload distributor 650 distributes the workload/chunks to the example worker TEEs (e.g., the first worker TEE 604, the second worker TEE 606, the third worker TEE 608 and/or the fourth worker TEE 610) (block 1050). In some examples, the example workload joiner (660) receives processed HE output data from the worker TEEs, 604, 606, 608, 610, and joins the outputs to form a single workload output (block 1060). The example decomposition map generator 670 (FIG. 6) generates a decomposition map and the joined outputs and decomposition map are supplied as HE user output data to a user system that supplied the workload (block 1070). Thereafter the program 1000 ends.

FIG. 11 is a block diagram of an example processor platform 1100 structured to execute the instructions of FIG. 7 to implement the example MLMS 210 of FIG. 2 and/or the example MLMS (FaaS) 410 of FIG. 4 and/or FIG. 5. The processor platform 1100 can be, for example, a server, a personal computer, a workstation, a self-learning machine (e.g., a neural network), an Internet appliance, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements any of the example MLMS 210 of FIG. 2, example MLMS TEE 240 of FIG. 2, the example MLMS (FaaS) 410 (of FIG. 4 and FIG. 5), the example MLMS TEE 440 (of FIG. 4 and FIG. 5), the example machine learning model 420 (and components thereof) of FIG. 4 and FIG. 5, and/or the example first two party evaluator 470SP of FIG. 4 and FIG. 5.

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), a Bluetooth® interface, a near field communication (NFC) interface, and/or a PCI express interface.

In the illustrated example, one or more input devices 1122 are connected to the interface circuit 1120. The input device(s) 1122 permit(s) a user to enter data and/or commands into the processor 1112. The input device(s) can be implemented by, for example, an audio sensor, a microphone, a camera (still or video), a keyboard, a button, a mouse, a touchscreen, a track-pad, a trackball, isopoint and/or a voice recognition system. In some examples, the one or more input devices 1122 are used to enter any input data at the MLMS 210 (FIG. 2), and/or the MLMS (FaaS) 410 (FIGS. 4 and 5) required to implement the machine learning model, to enter information about a real-world system to be represented by the machine learning model, etc., as described above with respect to the FIGS. 2, 4 and 5.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1120 of the illustrated example, thus, typically includes a graphics driver card, a graphics driver chip and/or a graphics driver processor.

The interface circuit 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1126. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, redundant array of independent disks (RAID) systems, and digital versatile disk (DVD) drives.

The machine executable instructions 1132 (e.g., the program 700) of FIG. 7 may be stored in the mass storage device 1128, in the volatile memory 1114, in the non-volatile memory 1116, and/or on a removable non-transitory computer readable storage medium such as a CD or DVD. In some examples, any of the mass storage device 1128, the volatile memory 1114, the non-volatile memory 1116, etc., can be used to implement the second storage 292SP of FIG. 2 or the second storage 492SP of FIG. 4 and FIG. 5.

FIG. 12 is a block diagram of an example processor platform 1200 structured to execute the instructions of FIG. 8 or FIG. 9 to implement the example MLMS (FaaS) 410 and MLMS TEE 440SP of FIG. 4 and FIG. 5. The processor platform 1200 can be, for example, a server, a personal computer, a workstation, a self-learning machine (e.g., a neural network), an Internet appliance, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example MLMS (FaaS) 410 and the MLMS TEE 440 SP of FIG. 4 or FIG. 5, the example first two-party evaluator 470CBU (FIG. 5), the machine learning model 420 of FIG. 4 or FIG. 5.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), a Bluetooth® interface, a near field communication (NFC) interface, and/or a PCI express interface.

In the illustrated example, one or more input devices 1222 are connected to the interface circuit 1220. The input device(s) 1222 permit(s) a user to enter data and/or commands into the processor 1212. The input device(s) can be implemented by, for example, an audio sensor, a microphone, a camera (still or video), a keyboard, a button, a mouse, a touchscreen, a track-pad, a trackball, isopoint and/or a voice recognition system. In some examples, the one or more input devices 1222 are used to enter any input data at the cloud based user system 430 (FIG. 5) required to implement the example components of the MLMS (FaaS) 410 and the MLMS TEE 440SP of FIG. 4 or FIG. 5.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1220 of the illustrated example, thus, typically includes a graphics driver card, a graphics driver chip and/or a graphics driver processor.

The interface circuit 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1226 (e.g., the communication system 496A and/or 496B. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, redundant array of independent disks (RAID) systems, and digital versatile disk (DVD) drives. In some examples, any of the storage devices of FIG. 12 can be used to implement the 3rd storage 492SP of FIG. 4 or FIG. 5.

The machine executable instructions 1232 (e.g., portions of the program 900) of FIG. 8 and of FIG. 9 may be stored in the mass storage device 1228, in the volatile memory 1214, in the non-volatile memory 1216, and/or on a removable non-transitory computer readable storage medium such as a CD or DVD.

FIG. 13 is a block diagram of an example processor platform 1300 structured to execute a portion of the instructions (e.g., the instructions to the left of the dashed line) of FIG. 9 to implement the example cloud-based user TEE 430CBU of FIG. 5. The processor platform 1300 can be, for example, a server, a personal computer, a workstation, a self-learning machine (e.g., a neural network), an Internet appliance, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example cloud based user system 430CBU of FIG. 5, the example user TEE 440 (FIG. 5), the example third two-party evaluator 470CBU (FIG. 5), the example user data preparer 490CBU (FIG. 5) and/or the example intermediate computation tool 502 (FIG. 5).

The processor 1312 of the illustrated example includes a local memory 1313 (e.g., a cache). The processor 1312 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1316 may be implemented by flash memory and/or any other desired type of memory device. Access to the main memory 1314, 1316 is controlled by a memory controller. Any of the memory depicted in FIG. 13 can be used to implement the second storage 492CBU of the cloud based user system 430CBU.

The processor platform 1300 of the illustrated example also includes an interface circuit 1320. The interface circuit 1320 may be implemented by any type of interface standard, such as an Ethernet interface, a universal serial bus (USB), a Bluetooth® interface, a near field communication (NFC) interface, and/or a PCI express interface.

In the illustrated example, one or more input devices 1322 are connected to the interface circuit 1320. The input device(s) 1322 permit(s) a user to enter data and/or commands into the processor 1312. The input device(s) can be implemented by, for example, an audio sensor, a microphone, a camera (still or video), a keyboard, a button, a mouse, a touchscreen, a track-pad, a trackball, isopoint and/or a voice recognition system. In some examples, the one or more input devices 1322 are used to enter any input data at the cloud based user system 430CBU (FIG. 5) required to implement the example components of the user TEE 440CBU.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1320 of the illustrated example, thus, typically includes a graphics driver card, a graphics driver chip and/or a graphics driver processor.

The interface circuit 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1326 (e.g., the communication system 496A and/or 496B. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, redundant array of independent disks (RAID) systems, and digital versatile disk (DVD) drives.

The machine executable instructions 1332 (e.g., the portions of the program 900 to the left of the dashed line) may be stored in the mass storage device 1328, in the volatile memory 1314, in the non-volatile memory 1316, and/or on a removable non-transitory computer readable storage medium such as a CD or DVD.

FIG. 14 is a block diagram of an example processor platform 1400 structured to execute the instructions of FIG. 10 to implement the example scaled MLMS 603 of FIG. 6. The processor platform 1400 can be, for example, a server, a personal computer, a workstation, a self-learning machine (e.g., a neural network), an Internet appliance, or any other type of computing device.

The processor platform 1400 of the illustrated example includes a processor 1412. The processor 1412 of the illustrated example is hardware. For example, the processor 1412 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example supervisor TEE 602, the example workload analyzer 620, the example workload divider/decomposer 630, the example worker TEE instantiator/initiator 640, the example workload distributor 650, the example workload joiner 660 and/or the example decomposition map generator 670 of FIG. 6.

The processor 1412 of the illustrated example includes a local memory 1413 (e.g., a cache). The processor 1412 of the illustrated example is in communication with a main memory including a volatile memory 1414 and a non-volatile memory 1416 via a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1416 may be implemented by flash memory and/or any other desired type of memory device. Access to the main memory 1414, 1416 is controlled by a memory controller.

The processor platform 1400 of the illustrated example also includes an interface circuit 1420. The interface circuit 1420 may be implemented by any type of interface standard, such as an Ethernet interface, a universal serial bus (USB), a Bluetooth® interface, a near field communication (NFC) interface, and/or a PCI express interface.

In the illustrated example, one or more input devices 1422 are connected to the interface circuit 1420. The input device(s) 1422 permit(s) a user to enter data and/or commands into the processor 1412. The input device(s) can be implemented by, for example, an audio sensor, a microphone, a camera (still or video), a keyboard, a button, a mouse, a touchscreen, a track-pad, a trackball, isopoint and/or a voice recognition system. In some examples, the one or more input devices 1422 are used to enter any input data at the MLMS 603 required to implement the example components of the example supervisor TEE 602.

One or more output devices 1424 are also connected to the interface circuit 1420 of the illustrated example. The output devices 1424 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1420 of the illustrated example, thus, typically includes a graphics driver card, a graphics driver chip and/or a graphics driver processor.

The interface circuit 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1426. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1400 of the illustrated example also includes one or more mass storage devices 1428 for storing software and/or data. Examples of such mass storage devices 1428 include floppy disk drives, hard drive disks, compact disk drives, Blu-ray disk drives, redundant array of independent disks (RAID) systems, and digital versatile disk (DVD) drives.

The machine executable instructions 1432 (e.g., the program 1000) of FIG. 10 may be stored in the mass storage device 1428, in the volatile memory 1414, in the non-volatile memory 1416, and/or on a removable non-transitory computer readable storage medium such as a CD or DVD.

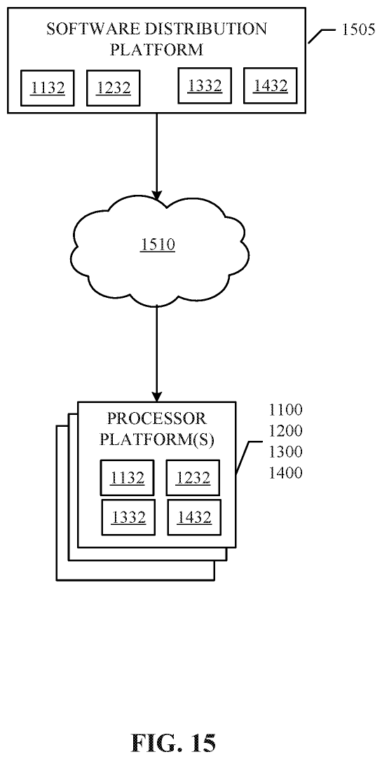

A block diagram illustrating an example software distribution platform 1505 to distribute software such as the example computer readable instructions 1132 of FIG. 11, the example computer readable instructions 1232 of FIG. 12, the example computer readable instructions 1332 of FIG. 13 and/or the example computer readable instructions 1432 of FIG. 14 to third parties is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 1132 of FIG. 11, the example computer readable instructions 1232 of FIG. 12, the example computer readable instructions 1332 of FIG. 13 and/or the example computer readable instructions 1432 of FIG. 14. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the computer readable instructions 1132, which may correspond to the example computer readable instructions 700 of FIG. 7, the computer readable instructions 1232 which may correspond to the example computer readable instructions 800 of FIG. 8, and a portion of the example computer readable instructions 900 of FIG. 9, the computer readable instructions 1332, which may correspond to the example computer readable instructions 900 of FIG. 9, and/or store the computer readable instructions 1432, which may correspond to the example computer readable instructions 1000 of FIG. 10, as described above.

The one or more servers of the example software distribution platform 1505 are in communication with a network 1510, which may correspond to any one or more of the Internet and/or any of the example networks 296, 496A and/or 496B described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 1132, 1232, 1332, 1432 from the software distribution platform 1505. For example, the software, which may correspond to the example computer readable instructions 700 of FIG. 7, the computer readable instructions 800 of FIG. 8 and at least a portion of the computer readable instructions 900 of FIG. 9, the computer readable instructions 900 of FIG. 9, the computer readable instructions 1000 of FIG. 10 may be downloaded to the example software distribution platform 1505 which can execute the computer readable instructions 1132, 1232, 1332, 1432 to implement the example system to provide a function as a service in the cloud based environment (and the components thereof) of FIGS. 1, 2, 3, 4, 5, and/or 6. Additionally or alternatively, the software which may correspond to the example computer readable instructions 700 of FIG. 7, the computer readable instructions 800 of FIG. 8, the example computer readable instructions 900 of FIG. 9 and/or the example computer readable instructions 1100 of FIG. 11, may be downloaded to the example processor platforms 1100, 1200, 1300, 1400, respectively. In some example, one or more servers of the software distribution platform 1505 periodically offer, transmit, and/or force updates to the software (e.g., the example computer readable instructions 1132 of FIG. 11, the example computer readable instructions 1232 of FIG. 12, the example computer readable instructions 1332 of FIG. 13, the example computer readable instructions 1432 of FIG. 14) to ensure improvements, patches, updates, etc. are distributed and applied to the software at the end user devices.

From the foregoing, it will be appreciated that example methods, apparatus and articles of manufacture have been disclosed that prevent the unauthorized release of in-use user data to be input to a FaaS (e.g., a machine learning model service) as well as in-use proprietary information constituting the FaaS service (e.g., the machine learning model, or portions therof). The disclosed methods, apparatus and articles of manufacture improve the efficiency of using a computing device by removing the unauthorized release of information (caused from a FaaS implemented in a cloud environment thereby reducing the labor and cost of dealing with such a release and reducing any downtime that might be associated with such a release. The disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

Example 1 is a system to prevent unauthorized release of in-use information. The system of Example 1 includes a function as a service associated with a service provider. The function as a service operates on encrypted data that includes encrypted in-use data and the encrypted in-use data forms a first portion of the in-use information. The system of Example 1 also includes a trusted execution environment (TEE) to operate within a cloud-based environment of a cloud provider. The function as a service operates on the encrypted data within the TEE which protects service provider information from access by the cloud provider and the service provider information forms a second portion of the in-use information.

Example 2 includes the system of Example 1. In Example 2, the function as a service is implemented with a machine learning model.

Example 3 includes the system of Example 2. In the system of Example 3, the encrypted data is homomorphically encrypted data that can be operated on by the machine learning model without undergoing decryption.

Example 4 includes the system of Example 2. In the system of Example 4, the encrypted data is homomorphically encrypted data. Additionally, the system of Example 4 a first encryptor, the first encryptor to use a two-party encryption technique to at least one of decrypt or encrypt information. The information includes at least one of a security guarantee, a homomorphic encryption (HE) schema of the homomorphically encrypted data, or an evaluation key.

Example 5 includes the system of Example 4. In Example 5, the system further includes a machine learning framework developer implemented in the TEE that develops the machine learning framework. The system of Example 5 further includes a machine learning intellectual property developer to develop at least one of unencrypted coefficients or unencrypted biases of the machine learning model. Additionally, the system includes a model evaluator that is implemented in the TEE. The model evaluator performs one or more operations on the encrypted data within the TEE and the model evaluator generates homomorphically encrypted output data using the framework and using the unencrypted coefficients and/or unencrypted biases.

Example 6 includes the system of Example 2. In Example 6, the encrypted data is homomorphically encrypted data, and the system also includes an encryptor implemented in the TEE. The encryptor uses a two-party encryption technique to decrypt and encrypt communications with a processor associated with a source of the homomorphically encrypted data. The communications include information to identify a scaling factor of the machine learning model. The system also includes a model evaluator implemented in the TEE. The model evaluator performs operations of the machine learning model on the homomorphically encrypted data. Additionally, the system includes a noise budget counter to count a number of the operations performed, a comparator to compare the count to a threshold and a trigger cause an output of a most recently performed set of the operations to be supplied to the processor associated with the source of the homomorphically encrypted data, when the count satisfies the threshold. The output of the most recently performed set of operations is homomorphically encrypted.

Example 7 includes the system of Example 6. In the system of Example 7, the trigger resets the counter to zero after the count satisfies the threshold.

Example 8 includes the system of Example 2. In Example 8, the encrypted data is first homomorphically encrypted data, and the system further includes an encryptor, implemented in the TEE. The encryptor uses a two-party encryption technique to decrypt and encrypt communications with a processor associated with a source of the homomorphically encrypted data. The communications include information to identify one or more non-linear operations of the machine learning model. Additionally, the first homomorphically encrypted data is operated on by the processor associated with a source of the homomorphically encrypted data in an unencrypted state using the non-linear operations.

Example 9 includes the system of Example 2. In Example 9, the encrypted data is received from a user processing system implemented in the cloud based environment.

Example 10 includes the system of Example 2. In Example 10 the encrypted in-use data includes data provided by a processor associated with a source of the encrypted in-use data. The encrypted in-use data is operated on by the machine learning model, and the service provider information includes one or more coefficients and a machine learning model framework. The coefficients and the machine learning model framework form the machine learning model.

Example 11 includes at least one non-transitory computer readable storage medium having instructions that, when executed, cause at least one processor to at least instantiate a trusted execution environment (TEE) to operate in a cloud based environment of a cloud provider. The Tee prevents the cloud provider from accessing in-use information contained in the TEE. The instructions of Example 11 also cause the processor to operate, in the TEE, on encrypted data using a function as a service. The encrypted data is received from a user system and includes encrypted in-use data.

Example 12 includes the at least one computer readable storage medium of Example 11. In Example 12, the function as a service is implemented with a machine learning model, and the encrypted data is homomorphically encrypted data that is operated on by the machine learning model without undergoing decryption.

Example 13 includes the at least one computer readable storage medium of Example 12. In Example 12, the instructions are further to cause the at least one processor to at least one of encrypt or decrypt information with a two-party encryption technique. In Example 12, the information includes at least one of a security guarantee, a homomorphic encryption (HE) schema of the homomorphically encrypted data, or an evaluation key.

Example 14 includes the at least one computer readable storage medium of Example 12. In Example 14, the homomorphically encrypted data is homomorphically encrypted input data, and the instructions further cause the at least one processor to generate, in the TEE, a machine learning framework, to develop, in the TEE, at least one of unencrypted coefficients or unencrypted biases to form a part of the machine learning model, and to perform, in the TEE, one or more operations on the homomorphically encrypted input data to generate homomorphically encrypted output data. In Example 14, the operations use the framework and the at least one of the unencrypted coefficients or unencrypted biases.

Example 15 includes the at least one computer readable storage medium of Example 12. In Example 15, the homomorphically encrypted data is homomorphically encrypted input data, and the instructions further cause the at least one processor to count a number of operations performed on the homomorphically encrypted input data by the machine learning model, compare the number to a threshold, and, when the number satisfies the threshold, cause the homomorphically encrypted output data of a most recently performed set of the operations to be supplied to the user system.

Example 16 includes the at least one computer readable storage medium of Example 15. In Example 16, the instructions further cause the number to be reset to zero after the threshold is satisfied.

Example 17 includes the at least one computer readable storage medium of Example 12. In Example 17, the instructions further cause the at least one processor to encrypt, in the TEE, an output communication. The output communication is encrypted using a two party encryption technique, and the output communication identifies one or more non-linear operations of the machine learning model.

Example 18 includes the at least one computer readable storage medium of Example 12. In Example 18, the instructions are further to cause the at least one processor to generate one or more coefficients and a machine learning model framework, and the coefficients and the machine learning model framework form the machine learning model.

Example 19 is a method to provide a function as a service in a cloud-based environment of a cloud provider. The method of Example 19 includes instantiating a trusted execution environment (TEE) to operate in the cloud based environment of the cloud provider. The TEE prevents the cloud provider from accessing in-use information contained in the TEE. The method also includes operating, in the TEE, on homomorphically encrypted data using the function as a service. The homomorphically encrypted data is received from a user system and the homomorphically encrypted data includes homomorphically encrypted in-use data.

Example 20 includes the method of Example 19. In Example 20, the function as a service is a machine learning model. In addition, in Example 20, the method includes decrypting, with a two way decryption technique, information received from the user system. The information includes at least one of a security guarantee, a homomorphic encryption (HE) schema of the homomorphically encrypted data, or an evaluation key. In Example 20, wherein the homomorphically encrypted data operated on based on at least one of the security guarantee, the HE schema of the homomorphically encrypted data, or the evaluation key.

Example 21 includes the method of Example 20. In method of Example 21 also includes generating a machine learning framework, and developing at least one of unencrypted coefficients or unencrypted biases for the machine learning model. The machine learning framework and at least one of the unencrypted coefficients or the unencrypted biases are to be used by the machine learning model. In the method of Example 21, the framework and at least one of the unencrypted coefficients or unencrypted biases form at least a portion of the in-use information.

Example 22 includes the method of Example 20. In Example 22, the operations are nested operations and the method also includes counting a number of the operations performed on the homomorphically encrypted data, comparing the number to a threshold, and when the number satisfies the threshold, causing an output of a most recently performed set of the operations to be supplied to the user system.

What is claimed is:

1. A system to prevent unauthorized release of in-use information, the system comprising:
a function as a service associated with a service provider, the function as a service to operate on encrypted data, the encrypted data including encrypted in-use data, the encrypted in-use data to form a first portion of the in-use information; and
a trusted execution environment (TEE) to operate within a cloud-based environment of a cloud provider, the function as a service to operate on the encrypted data within the TEE, the TEE to protect service provider information from access by the cloud provider, the service provider information to form a second portion of the in-use information.

2. The system of claim 1, wherein the function as a service is implemented with a machine learning model.

3. The system of claim 2, wherein the encrypted data is homomorphically encrypted data that can be operated on by the machine learning model without undergoing decryption.

4. The system of claim 2, wherein the encrypted data is homomorphically encrypted data, and further including a first encryptor, the first encryptor to use a two-party encryption technique to at least one of decrypt or encrypt information, the information to include at least one of a security guarantee, a homomorphic encryption (HE) schema of the homomorphically encrypted data, or an evaluation key.

5. The system of claim 4, further including:
a machine learning framework developer implemented in the TEE, the machine learning framework developer to develop the machine learning framework;
a machine learning intellectual property developer to develop at least one of unencrypted coefficients or unencrypted biases of the machine learning model; and
a model evaluator implemented in the TEE, the model evaluator to perform one or more operations on the encrypted data within the TEE, the model evaluator to generate homomorphically encrypted output data using the framework and the at least one of unencrypted coefficients or unencrypted biases.

6. The system of claim 2, wherein the encrypted data is homomorphically encrypted data, and further including:
an encryptor implemented in the TEE, the encryptor to use a two-party encryption technique to decrypt and encrypt communications with a processor associated with a source of the homomorphically encrypted data, the communications to include information to identify a scaling factor of the machine learning model;
a model evaluator, implemented in the TEE, the model evaluator to perform operations of the machine learning model on the homomorphically encrypted data;
a noise budget counter to count a number of the operations performed;
a comparator to compare the count to a threshold; and
a trigger to, when the count satisfies the threshold, cause an output of a most recently performed set of the operations to be supplied to the processor associated with the source of the homomorphically encrypted data, the output of the most recently performed set of operations to be homomorphically encrypted.

7. The system of claim 6, wherein the trigger is to reset the counter to zero after the count satisfies the threshold.

8. The system of claim 2, wherein the encrypted data is first homomorphically encrypted data, and further including:
an encryptor, implemented in the TEE, the encryptor to use a two-party encryption technique to decrypt and encrypt communications with a processor associated with a source of the homomorphically encrypted data, the communications to include information to identify one or more non-linear operations of the machine learning model, the first homomorphically encrypted data to be operated on by the processor associated with a source of the homomorphically encrypted data in an unencrypted state using the non-linear operations.

9. The system of claim 2, wherein the encrypted data is received from a user processing system implemented in the cloud based environment.

10. The system of claim 2, wherein the encrypted in-use data includes data provided by a processor associated with a source of the encrypted in-use data, the encrypted in-use data to be operated on by the machine learning model, and the service provider information includes one or more coefficients and a machine learning model framework, the coefficients and the machine learning model framework forming the machine learning model.

11. At least one non-transitory computer readable storage medium comprising instructions that, when executed, cause at least one processor to at least:
instantiate a trusted execution environment (TEE) to operate in a cloud based environment of a cloud provider, the TEE to prevent the cloud provider from accessing in-use information contained in the TEE; and
operate, in the TEE, on encrypted data using a function as a service, the encrypted data received from a user system, the encrypted data including encrypted in-use data.

12. The at least one computer readable storage medium of claim 11 wherein the function as a service is implemented with a machine learning model, and the encrypted data is homomorphically encrypted data that is operated on by the machine learning model without undergoing decryption.

13. The at least one computer readable storage medium of claim 12, wherein the instructions are further to cause the at least one processor to at least one of encrypt or decrypt information with a two-party encryption technique, the information to include at least one of a security guarantee, a homomorphic encryption (HE) schema of the homomorphically encrypted data, or an evaluation key.

14. The at least one computer readable storage medium of claim 12, wherein the homomorphically encrypted data is homomorphically encrypted input data, and the instructions are further to cause the at least one processor to:
generate, in the TEE, a machine learning framework;
develop, in the TEE, at least one of unencrypted coefficients or unencrypted biases to form a part of the machine learning model; and
perform, in the TEE, one or more operations on the homomorphically encrypted input data to generate homomorphically encrypted output data, the operations to use the framework and the at least one of the unencrypted coefficients or unencrypted biases.

15. The at least one computer readable storage medium of claim 12, wherein the homomorphically encrypted data is homomorphically encrypted input data, and the instructions are further to cause the at least one processor to:
count a number of operations performed on the homomorphically encrypted input data by the machine learning model;
compare the number to a threshold; and
when the number satisfies the threshold, cause the homomorphically encrypted output data of a most recently performed set of the operations to be supplied to the user system.

16. The at least one computer readable storage medium of claim 15, wherein the instructions cause the number to be reset to zero after the threshold is satisfied.

17. The at least one computer readable storage medium of claim 12, wherein the instructions cause the at least one processor to encrypt, in the TEE, an output communication, the output communication encrypted using a two party encryption technique, the output communication to identify one or more non-linear operations of the machine learning model.

18. The at least one computer readable storage medium of claim 12, wherein the instructions are further to cause the at least one processor to generate one or more coefficients and a machine learning model framework, the coefficients and the machine learning model framework forming the machine learning model.

19. A method to provide a function as a service in a cloud-based environment of a cloud provider, the method comprising:
instantiating a trusted execution environment (TEE) to operate in the cloud based environment of the cloud provider, the TEE to prevent the cloud provider from accessing in-use information contained in the TEE; and
operating, in the TEE, on homomorphically encrypted data using the function as a service, the homomorphically encrypted data received from a user system, the homomorphically encrypted data including homomorphically encrypted in-use data.

20. The method of claim 19, wherein the function as a service is a machine learning model, and further including:
decrypting, with a two way decryption technique, information received from the user system, the information to include at least one of a security guarantee, a homomorphic encryption (HE) schema of the homomorphically encrypted data, or an evaluation key, wherein the operating on the homomorphically encrypted data is based on the at least one of the security guarantee, the HE schema of the homomorphically encrypted data, or the evaluation key.

21. The method of claim 20, further including:
generating a machine learning framework; and
developing at least one of unencrypted coefficients or unencrypted biases for the machine learning model, the machine learning framework and at least one of the unencrypted coefficients or the unencrypted biases to be used by the machine learning model, and the framework and the at least one of the unencrypted coefficients or unencrypted biases to form at least a portion of the in-use information.

22. The method of claim 20, wherein the operations are nested operations and further including:
counting a number of the operations performed on the homomorphically encrypted data;
comparing the number to a threshold; and
when the number satisfies the threshold, causing an output of a most recently performed set of the operations to be supplied to the user system.
